(19) United States
(12) Patent Application Publication
(10) Pub. No.: US 2023/0289893 A1
(43) Pub. Date: Sep. 14, 2023

(54) SYSTEM AND METHOD FOR ISSUING AND TRACKING FUNDING FOR CONTRACTING SERVICES

(71) Applicant: F.M.D. Holdings, LLC, Lubbock, TX (US)

(72) Inventors: Ryan Davis, Pflugerville, TX (US); Kris Kincaid, Lubbock, TX (US); Brandi Hickson, Lubbock, TX (US)

(73) Assignee: F.M.D. Holdings, LLC, Lubbock, TX (US)

(21) Appl. No.: 18/319,171

(22) Filed: May 17, 2023

Related U.S. Application Data
(63) Continuation-in-part of application No. 17/301,220, filed on Mar. 29, 2021.
(60) Provisional application No. 63/000,967, filed on Mar. 27, 2020.

(51) Int. Cl. G06Q 40/08; H04W 4/02

(52) U.S. Cl. CPC G06Q 40/08; H04W 4/02

(57) ABSTRACT

The system provided allows weather data containing errors to be pre-processed in a way that quickly enhances data integrity which increases the efficiency and effectiveness of warnings. The system further provides a means to selectively distribute messages related to warnings to a group of recipients in a known geographic area. The system further comprises a way to advise recipients of property repair financing to address the needs of underinsured recipients.

### CROSS-REFERENCE TO RELATED APPLICATIONS

This application is a continuation-in-part of U.S. application Ser. No. 17/301,220 filed Mar. 29, 2021, which claims priority benefit from U.S. Provisional Application No. 63/000,967 filed on Mar. 27, 2020. The patent applications identified above are incorporated here by reference in their entirety to provide continuity of disclosure.

### FIELD OF THE INVENTION

The present invention relates to a system and method for providing severe storm warnings and a system which selectively provides funding contracting services with financed insurance deductibles.

### BACKGROUND OF THE INVENTION

Property damage caused by severe weather is a large and increasing problem in the United States.

For example, between 2017 and 2021, severe weather caused an estimated 121.4 billion dollars in property damages. It is estimated that about three quarters of these weather related damages were covered by insurance for a total of 92 billion dollars, which leaves an estimated 29.4 billion dollars not covered, hence resulting in vast personal property loss.

The National Oceanic and Atmospheric Association (NOAA) estimates that the number and cost of disaster related events are both rising. While the United States experienced about 53 billion dollars in weather related disasters between 2012 and 2016, it experienced about 84 billion dollars in weather related disasters between 2017 and 2021, including 51 severe storms, 18 tropical cyclones, seven flood events, four droughts, three winter storm storms, and one freeze event. Between 2017 and 2021, it is estimated that flash floods caused 49.1 billion dollars in damages, hurricanes caused 36.1 billion dollars in damages, tornadoes caused 7.1 billion dollars in damages.

Historically, meteorologists have been capable of identifying specific days where severe weather is likely. But warnings, which serve as immediate calls to action for specific locations are usually issued only minutes from local storm impact locations. Hence, there is a need to improve the system.

NOAA has made available data from numerous weather prediction models in order to provide probabilistic information related to forecasts. For example, NOAA makes data available of individual thunderstorms about six hours in advance with data updated about every half hour.

However, data provided by NOAA, and other weather centers, is often error-prone, including missing data, and data which is outside statistical norms. The lack of accurate data reduces the effectiveness and accuracy of the warnings.

Another problem associated with severe weather is the high cost associated with repairs necessitated by severe storms. Policy holders are required to purchase insurance in order to protect the value of their homes and vehicles in case of storm damage. However, not all repairs and medical expenses are covered by insurance. If insurance is not available, policy holders are often required to pay contractors upfront. Policy holders without the funds needed to cover the high costs of such repairs often rely on traditional loans from banks or they borrow against the mortgage.

When damage occurs that is covered by insurance a policy holder may file a claim on their insurance policy to recoup a portion of the repair costs. However, before the insurance policy will cover any repair costs, the policy holder must first meet a deductible.

Generally, in the insurance industry after a policy holder files a claim, they need a quote from a contractor with an estimate of the repair costs. The quote is then submitted to the insurance company for approval. Once the insurance company issues an approval, the insurance company will initially pay the policy holder the cost of repairs less the deductible and any depreciation. The policy holder must pay the full cost of the repair to the contractor. After the repairs are completed and proof of payment of the deductible has been received by the insurance company the policy holder may recover the depreciation from the insurance company.

One challenge is that deductibles for home repair are often thousands of dollars, which many policy holders do not have readily available. This results in higher costs to the insured, and the insurance company because repairs must be delayed until the policy holder can collect the deductible amount.

For example, policy holders may not have the requisite credit needed for a traditional deductible loan. Similarly, policy holders may not be eligible for either a secondary insurance policy or deductible instalment plan. For instance, a policy holder may not be eligible because the insurance company does not offer instalment plans, or the policy holder has poor payment history. Moreover, traditional alternative deductible payment means may not be available to a policy holder because the policy holder may not be able to afford the high premiums, or interest rates associated with such plans.

Similar problems exist for funding deductibles for insurance coverage for personal property, vehicles, boats and medical costs. Thus, there is a need in the art for an improved system and method for providing means to meet insurance deductibles.

The prior art has attempted to address the challenges in funding insurance deductibles in a number of ways.

For example, U.S. Pat. No. 8,406,162 to Haupt, et al., discloses a transmitter that transmits a time synchronized signal to a receiver system which receives data for specific geographic locations. The system remotely monitors weather data and transmits alert data to low powered devices in a residence using different frequencies. However, Haupt does not actively correct the data it receives or retransmit nor does it address the problems related with selectively financing repair costs resulting from severe weather.

U.S. Pat. No. 8,788,606, to Johnson, et al., discloses a system of multimedia alerting, which allows mobile devices to display severe weather and early warning messages in times of severe weather by receiving a specific message from an alert service provider such as the United States National Weather Service. However, Johnson fails to address data correction issues or message targeting related to repair funding.

As another example, U.S. Pat. No. 8,639,535 to Kazenas describes a system and method for providing a supplemental insurance policy to insure a deductible amount, and an alternate means for adding the deductible amount to the principal balance of a home loan. However, Kazenas does not describe a method for financing a deductible using a funding agreement that does not require insurance deductibles or refinancing a loan.

As another example, U.S. Publication No. 2018/0268489 to McDonnell, et al. describes a system and method for processing payments on a deductible installment plan through an insurance provider or deductible contractor. However, McDonnell does not describe a method for a obtaining a funding agreement through the contractor repairing the home.

Despite the attempts of the prior art, deficiencies remain in early warning weather forecast data distribution system and in relaying relevant messages to those affected to offset the financial loss caused by severe weather.

Deficiencies also remain in the prior art related to the availability of traditional means of alternative deductible payments which are required to enable rapid repairs of storm damage.

### SUMMARY OF THE INVENTION

The system provided allows weather data containing errors to be pre-processed in a way that quickly enhances data integrity which increases the efficiency and effectiveness of warnings. The system further provides a means to selectively distribute messages related to warnings to a group of recipients in a known geographic area. The system further comprises a way to advise recipients of property repair financing to address the needs of underinsured recipients.

The system provides a significant advantage over the prior art because it increases the efficiency of weather warnings and message distribution to recipients. It is also a significant improvement in the art because it allows rapid funding to increase the rate of repairs and disaster recovery. It also enables policy holders to meet their deductible and settle insurance claims at a much faster rate, and reduces any added expenses associated with using traditional loans.

### BRIEF DESCRIPTION OF THE DRAWINGS

FIG. 1A is network diagram of a preferred system.

FIG. 1B is an isometric view of a preferred external package of the data preprocessor.

FIG. 1C is an exploded isometric view of a preferred data preprocessor.

FIG. 1D is a hardware architecture diagram of a preferred data preprocessor.

FIG. 2 is a preferred flow chart of a method of providing deductible funding.

FIG. 3 is a preferred flow chart of a method of providing non-deductible funding.

FIGS. 4A through 4Z are a map of graphic user interfaces for a deductible funding system.

FIG. 5 is a screenshot of a graphic user interface for administrator access to a preferred embodiment.

FIG. 6 is a screenshot of a graphic user interface for partner access to a preferred embodiment.

FIG. 7 is a screenshot of a graphic user interface for contractor access to a preferred embodiment.

FIG. 8 is a screenshot of a graphic user interface for sales staff access to a preferred embodiment.

FIG. 9 is a screenshot of a graphic user interface for customer access to a preferred embodiment.

FIGS. 10A and 10B is a flow chart of a preferred method of severe weather notification.

FIG. 10C is an architecture diagram of a preferred data preprocessor.

### DETAILED DESCRIPTION OF THE INVENTION

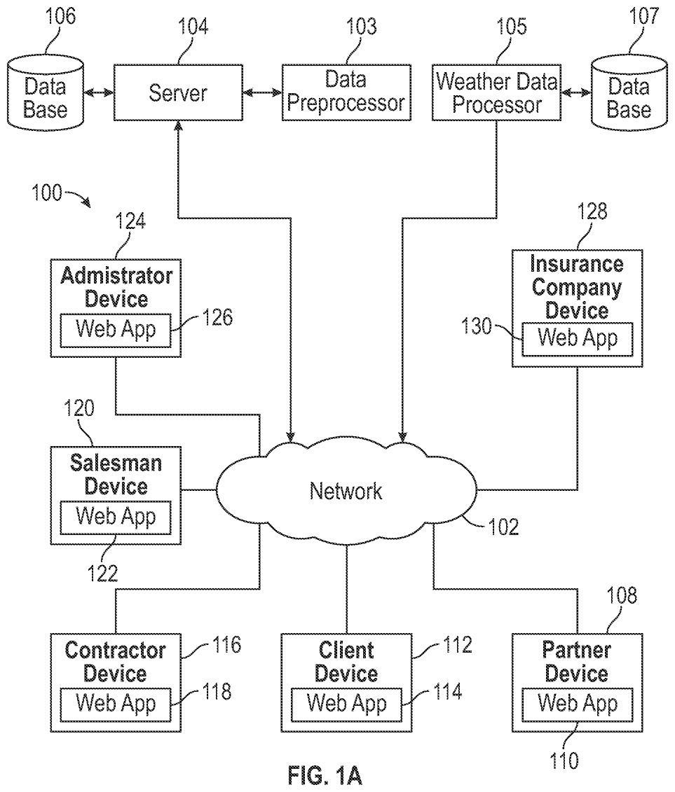

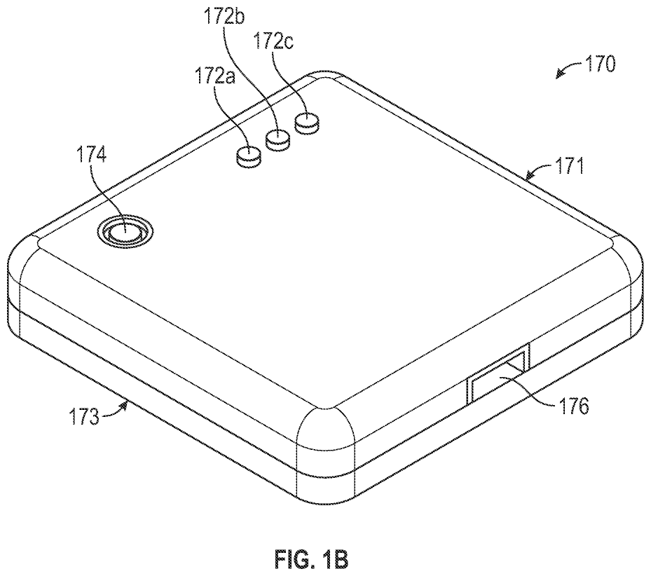

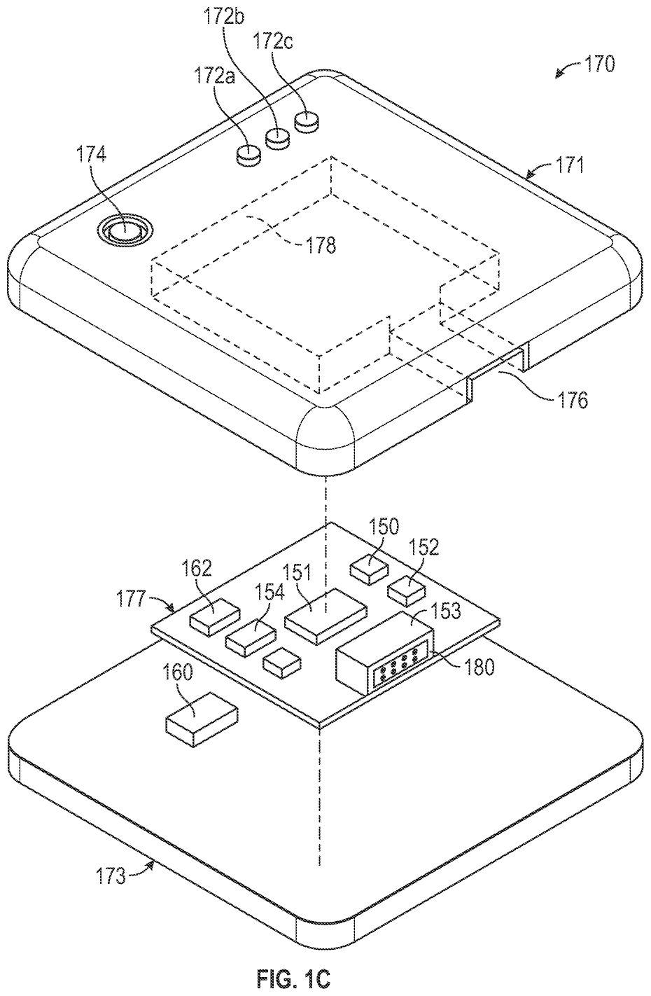

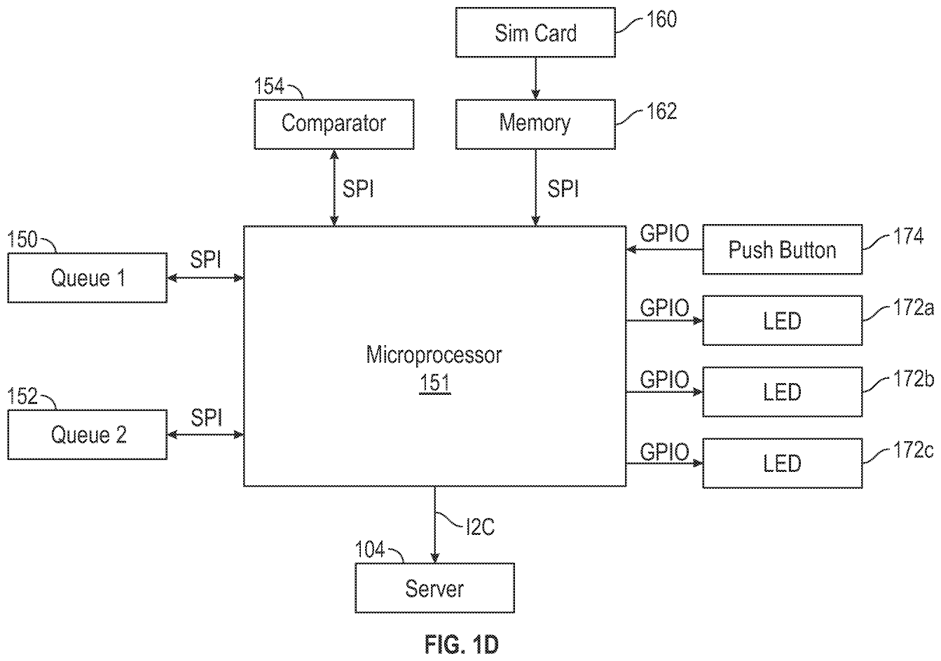

Referring then to FIG. 1A, a preferred embodiment of system 100 for issuing and tracking funded deductibles is shown.

System 100 is comprised of server 104 operatively connected to database 106. The system server is connected to wide area network 102, such as the internet. The system is further comprised of administrator device 124, salesman device 120, partner device 108, contractor device 116, and client device 112, each connected to the system server through network 102. Devices 108, 112, 116, 120, and 124 are each a smart device such as a computer, tablet, or cell phone. Devices 108, 112, 116, 120, and 124 include web applications 110, 114, 118, 122, 126, respectively. In a preferred embodiment, the web applications are each internet browsers. In alternate embodiments, the web application may also be a dedicated application installed on a device.

System 100 is further comprised of insurance company device 128 connected to network 102. In a preferred embodiment, insurance company device 128 is a server running web app 130. In another embodiment, insurance company device 128 is a smart device, such as a computer, associated with a third-party insurance carrier's agent, running web app 130. In a preferred embodiment, the web app 130 is an internet browser, or a dedicated application installed on the device, such as an email client or insurance related software. In a preferred embodiment, server 104 is connected to insurance company device 128 through network 102. In alternate embodiments, devices 108, 112, 116, 120, and 124 are each connected to the insurance device through network 102.

Server 104 is further connected directly to data preprocessor 103 through a I2C bus, as will be further described. Server 104 is operatively connected to weather data processor 105, through network 102, and communicates with it through an application programming interface (API). Weather data processor 105 is operatively connected to mass database 107.

Referring to FIG. 1B, preferred external package 170 of data preprocessor 103 will be further described. External package 170 includes top 171 sealed to bottom 173. Both top 171 and bottom 173 are preferably formed of a durable plastic, such as HDPE, Teflon®, or Delrin®.

Top 171 includes activation button 174 and externally visible LED 172a, LED 172b, and LED 172c. LEDs 172a, 172b, and 172c all communicate with microprocessor 151 through a GPIO connection. LED 172a is used to indicate power on. LED 172b is used to indicate data communications with the server. LED 172c is used to indicate an error or a lock up condition. Likewise, push button 174 communicates with microprocessor 151 through a GPIO connection. Push button 174 provides a boot up or power on signal, and a stop interrupt signal.

Referring also to FIG. 1C, top 171 includes internal rectangular void 178, including portal 176. Portal 176 is provided for external connections, as will be further described. PC board 177 is positioned in void 178 and preferably encapsulated during manufacture by an epoxy resin. The PC board serves to mechanically support and electronically connect the components of the data preprocessor. PC board 177 further includes connector 153 which is accessible through portal 146, for connection to the server. Bottom 173 is attached to top 171 by a permanent industrial adhesive which seals PC board 177 in void 178.

Microprocessor 151 is operatively connected to memory 162. In one embodiment, microprocessor 151 includes both internal memory and removable memory such as sim card 160, which is installed before the unit is assembled.

Memory 162 communicates with microprocessor 151 through an SPI connection. PC board 177 further includes I2C connector 180. I2C connector 180 is accessible through portal 176.

Referring also to FIG. 1D, Data preprocessor 103 is preferably implemented in hardware, so the speed and accuracy of the average replacement data generated is high, as will be further described. Data preprocessor 103 comprises microprocessor 151 operatively connected to data queues 150 and 152, and comparator 154. In a preferred embodiment, microprocessor 151, is preferably the Arduino GIGA R1 Wi-Fi, part number ABX00063, available from Arduino, of Turin, Italy. Microprocessor 151 is preferably the STM32H7 microcontroller which includes a Cortex RM7 core, operating at 480 MHz and a Cortex M4 core, operating at 240 MHz. Both cores are 32-bit microcontrollers. Preferably, microprocessor 151 implements average generator 156, in the M4 core, which allows it to run separately, as will be further described.

Microprocessor 151 is operatively connected to server 104 through an I2C synchronous serial communication bus.

Microprocessor 151 is operatively connected to data queue 150 and data queue 152 preferably using a serial peripheral interface (SPI) bus.

Preferably, data queue 150 is a single 128-bit shift register, such as the 128-bit static shift register with MOS P-channel and in-channel enhancement mode devices, part number MC14562BCL, available from Digichip. Data queue 150 preferably, is a first-in-first-out queue which includes five data blocks, which are periodically updated. Each data block includes an 8-bit timestamp designation and an 8-bit alert type designation, coded in hexadecimal notation. Data block 5, data block 4, data block 3, data block 2, and data block 1 contain data from the five downloads of timestamp and corresponding alert type data from the API that immediately precede data block 0. The queue is updated by the M7 core with a new data block from the server each time a new weather alert is received by the server from weather data processor 105.

Preferably, data queue 152 is a single 120-bit shift register, such as part number MC14562BCL, as previously described. Data queue 152 is also operatively connected to microprocessor 151, preferably using an SPI bus. Data queue 152 includes a single data block, data block 0. Data block 0 includes two 8-bit data entries, one for each of the current timestamp and the current alert type, received in the M7 core, from the server. The current timestamp and the current alert type are the most recent data received by the server, from the weather data processor through the API.

Comparator 154 is preferably a combinational logic circuit, used to compare the value of binary digits and is also connected to microprocessor 151 through an SPI bus. Comparator 154 is used to quickly determine whether or not an integrity error is present in the weather alert data stream from the weather data processor by making two data comparisons in bitwise fashion. The preferred embodiment, comparator 154 includes both a 16-bit address comparator, part number SN74ALS677A, available from Texas Instruments of Dallas Tex. and a 16-bit magnitude comparator, part number CD4585BE, available from Texas Instruments.

Data preprocessor 103 further comprises average generator 156, operatively connected to comparator 154 and data queues 150 and 152. In a preferred embodiment, average generator 156 is implemented by the M4 core of the microprocessor, from software resident in onboard memory. Average generator 156 is used to determine the “average” alert data type and the “average” timestamp when a data integrity error has been indicated by the data comparator.

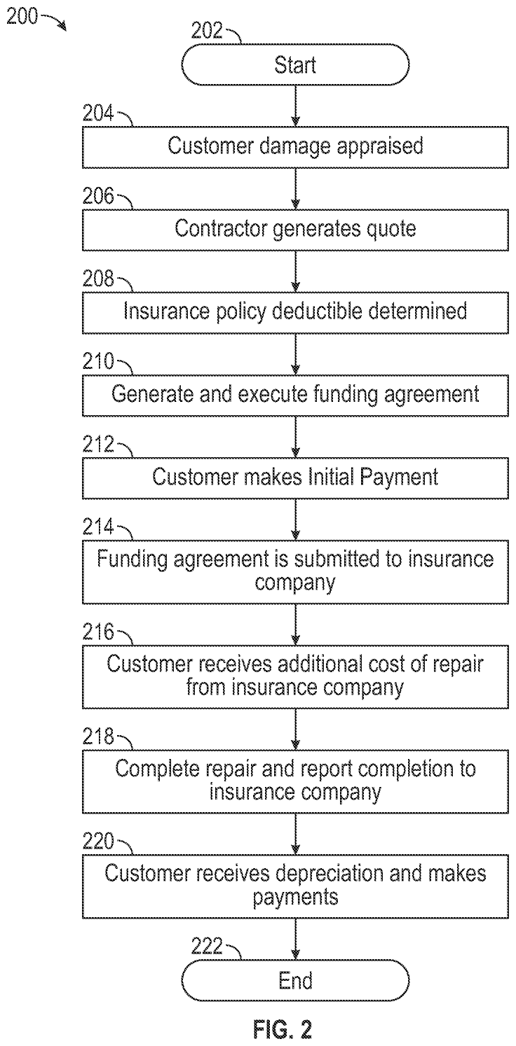

Referring then to FIG. 2, preferred method 200 for issuing and tracking funded deductibles will be described.

At step 202, the method is initiated when an insurance claim is made at client device 112 to repair a home under an insurance policy.

At step 204, the damage is initially appraised by an insurance appraiser who will also determine any depreciation value. The damage appraisal is received and stored at insurance company device 128.

At step 206, a contractor assesses the damage and generates a repair quote. The quote is transmitted to the client device for approval. In alternate embodiments, the quote may be generated at the salesman device, administrator device, or partner device and may be submitted to the insurance company device or the system server.

At step 208, the insurance policy claim details are provided and the deductible is determined based on the policy holder's insurance policy. In a preferred embodiment, this step is performed at contractor device 116 and submitted to server 104. In another embodiment, this may also be performed at administrator device 124, salesman device 120, client device 112, partner device 108, and insurance company device 128.

At step 210, a funding agreement is generated at contractor device 116 and transmitted to server 104. When the funding agreement is generated, the amount being funded, and the number of payments are input. The system server then calculates a payment plan and the monthly payments. The system server sends the funding agreement to the policy holder, and then to client device 112. The funding agreement is executed by the policy holder and returned and saved to the system server. In a preferred embodiment, the funding agreement is generated at the contractor device. In alternate embodiments, the funding agreement may be generated at a salesman device, a partner device, an administrator device, or automatically by the system server.

The funding agreement may cover the entire cost of the deductible, based on the appraisal, or may be for a lesser amount. The agreement sets out a payment plan to cover the full funded amount. As part of the agreement, the policy holder agrees to pay the contractor the full amount of the deductible owed, under the terms of the payment plan, and in exchange the contractor provides confirmation to the insurance company that the deductible is paid by agreement.

The funding agreement may also be a customized text document which describes a roof deductible funding product, a vehicle deductible funding product, a health deductible funding product, and/or a boat deductible funding product. In each case, specifics about the deductible amount and financing options can vary between each product.

At step 212, after the funding agreement is executed and returned to the system server, the policy holder makes an initial payment on the agreement at the client device. In a preferred embodiment, the customer must make at least one initial payment on the funding agreement before the deductible payment is certified to the insurance company. In other embodiments, a larger number of payments may be required before the deductible payment is certified.

At step 214, once the initial payment/s are made according to the funding agreement, the agreement is certified to the insurance company. In a preferred embodiment, the system server automatically transmits an executed funding agreement to the insurance company device. In alternate embodiments, the agreement may be transmitted to the insurance company device by a partner device, salesman device, or an administrator device.

At step 216, the insurance company will provide the customer with the funds required to cover the additional costs of the repair.

At step 218, once the repair costs have been paid, the contractor completes the repair and reports the completion to the insurance company. In a preferred embodiment, the contractor device transmits a completion report to the insurance company device. In an alternate embodiment, the completion report is received at the system server which transmits the report to the insurance company device. Similarly, completion may also be certified by a salesman device, partner device, or administrator device.

At step 220, after the insurance company verifies the repair is complete, it will issue funds for any depreciation amount withheld from earlier funds. The policy holder must continue to make payments according to the terms of the funding agreement. The system server tracks payments and remaining balances.

At step 222, the method ends when the final payment is submitted to the system server under the terms of the funding agreement.

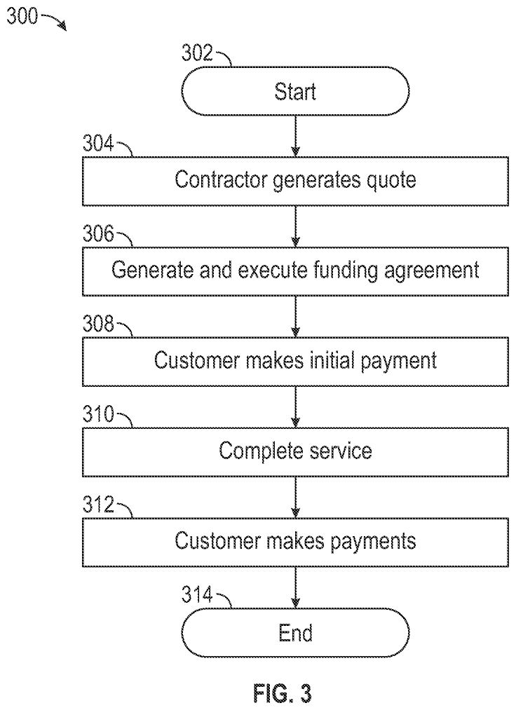

Referring to FIG. 3, preferred method 300 for issuing and tracking non-deductible funds will be described. Non-deductible funds may be issued in addition to or in lieu of deductible funds.

At step 302, the method is initiated when a customer requests a service quote for a home repair, upgrade, renovation, or remodel. In a preferred embodiment, the request is made at client device 112.

At step 304, a contractor assesses the project and generates a service quote. The quote is transmitted to the client device for approval. In alternate embodiments, the quote may be generated at the salesman device, administrator device, or partner device and may be submitted to the system server.

At step 306, a funding agreement is generated at contractor device 116 and transmitted to server 104. When the funding agreement is generated, the amount being funded, and the number of payments are input. The system server then calculates a payment plan and the monthly payments. The system server sends the funding agreement to the policy holder, and then, to client device to be executed, as previously described. The funding agreement may be generated at the contractor device, salesman device, a partner device, an administrator device, or automatically by the system server, as previously described.

The funding agreement may cover the full cost of the service, or a smaller amount. The agreement sets out a payment plan to cover the full funded amount. As part of the agreement, the policy holder agrees to pay the contractor the full amount of the service fee.

At step 308, after the funding agreement is executed, the policy holder makes an initial payment on the agreement at the client device. The payments are submitted to the system server. The system server tracks payments and remaining balances and updates the web application. In a preferred embodiment, the customer must make at least one initial payment on the funding agreement before the service begins. In other embodiments, a larger number of payments may be required before service begins.

At step 310, the service is completed.

At step 312, the customer continues to make payments at the client device according to the terms of the funding agreement. The system tracks payments and remaining balances.

At step 314, the method ends after the final payment is submitted to the system server under the terms of the funding agreement.

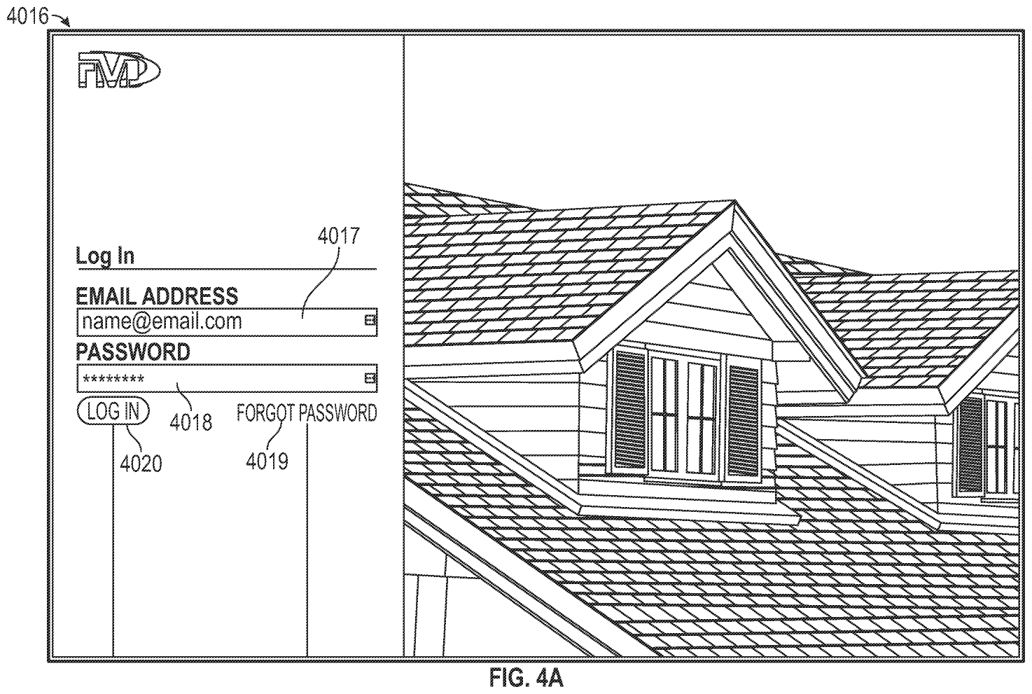

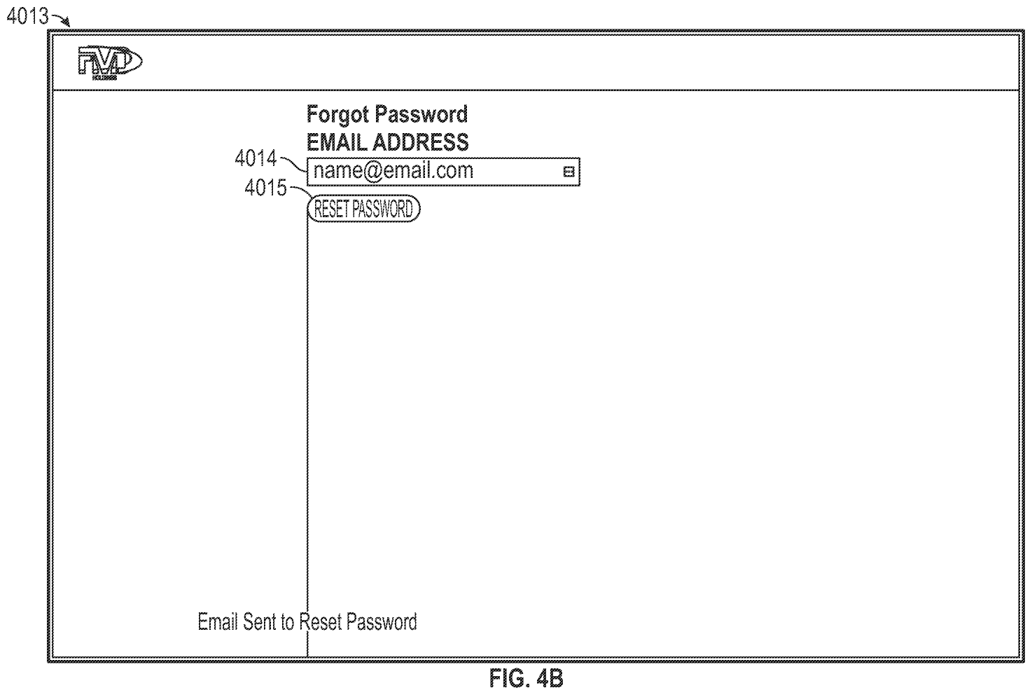

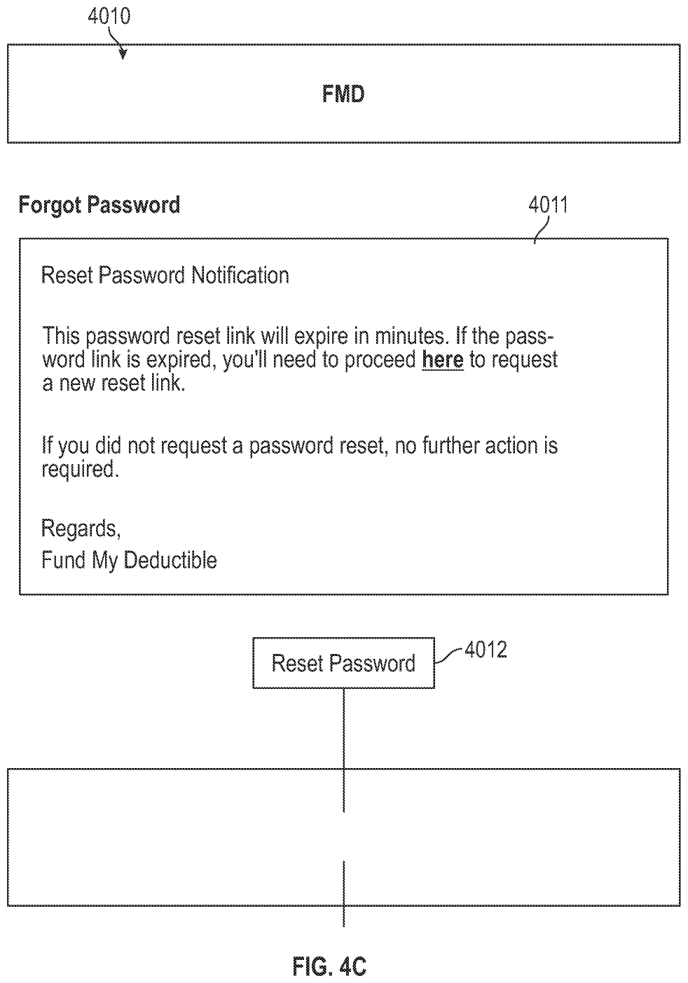

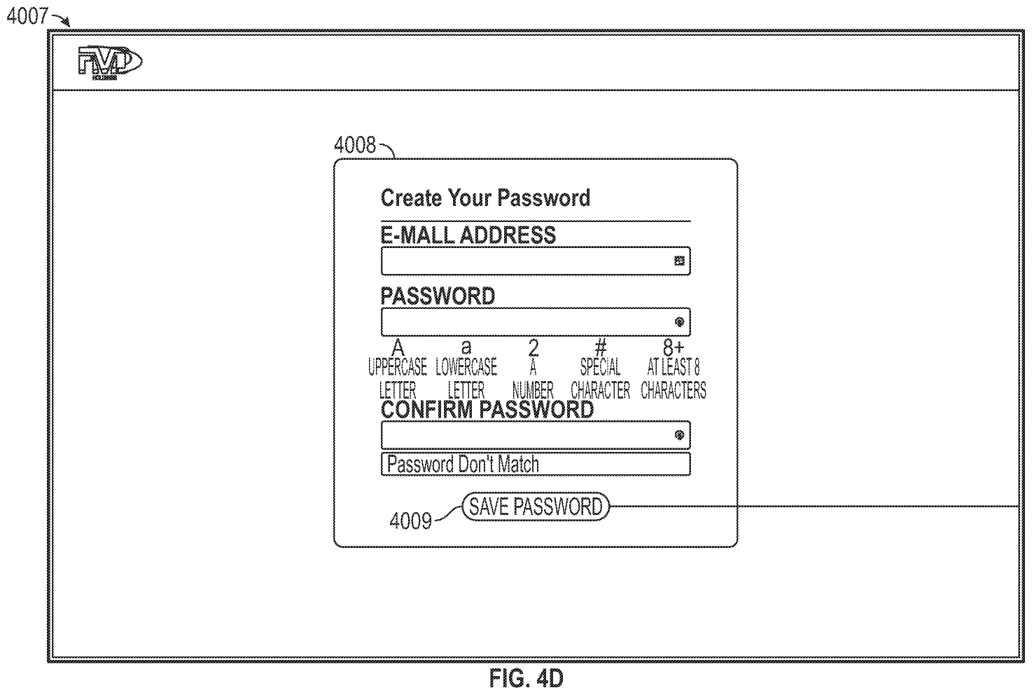

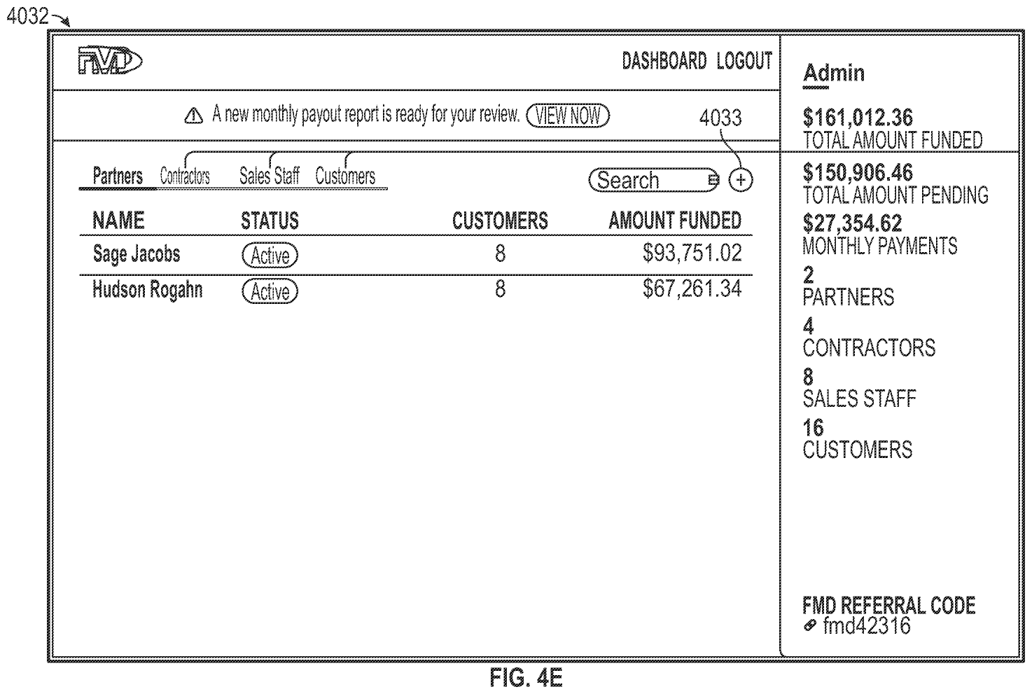

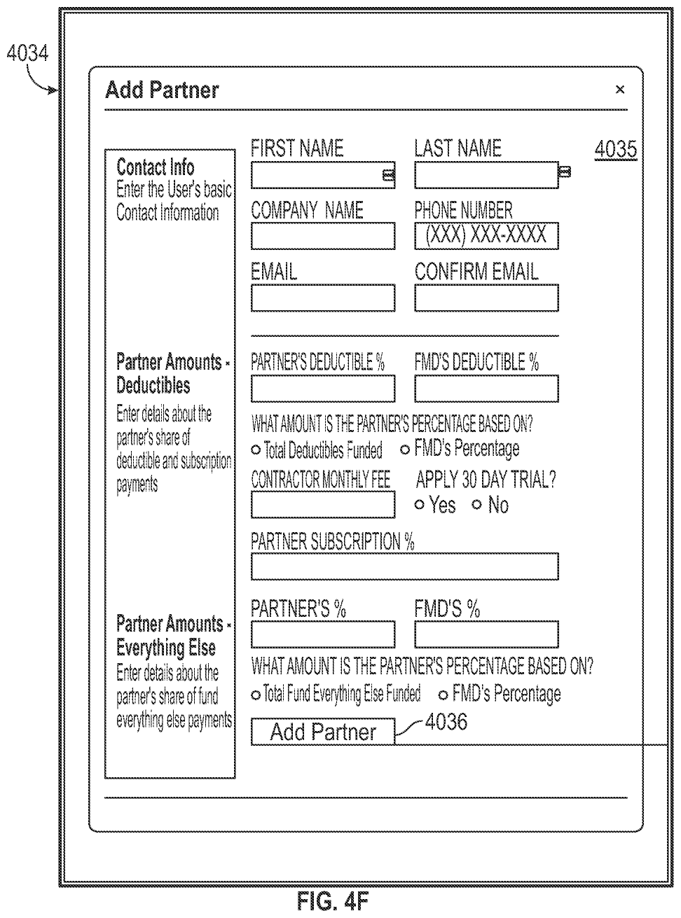

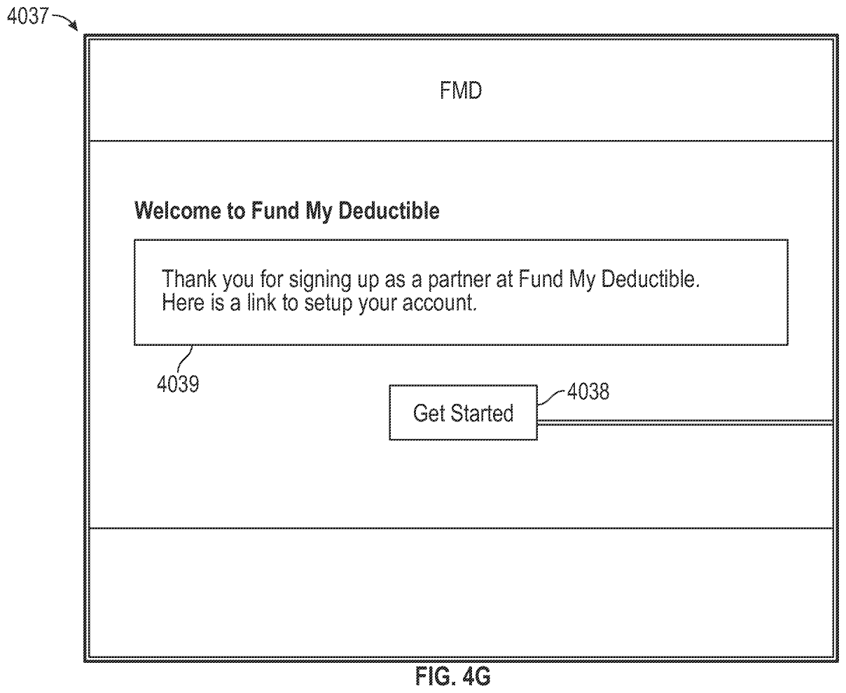

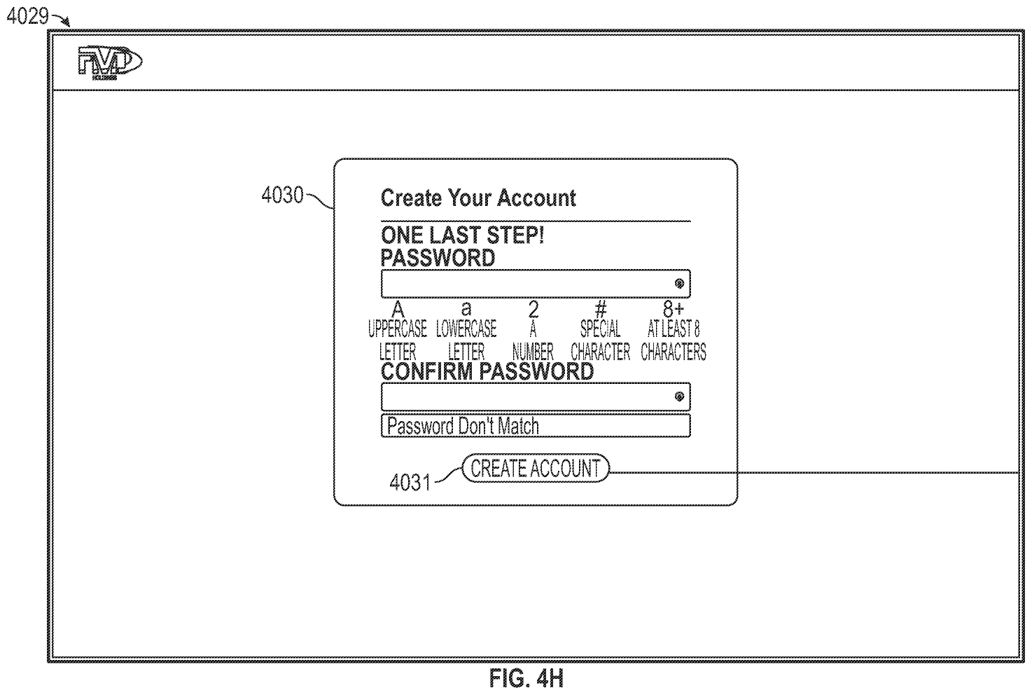

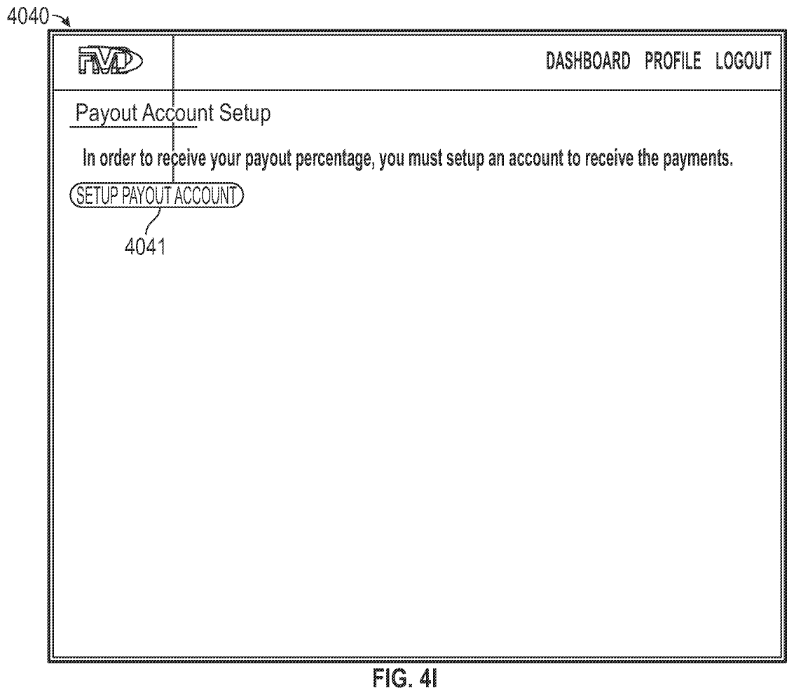

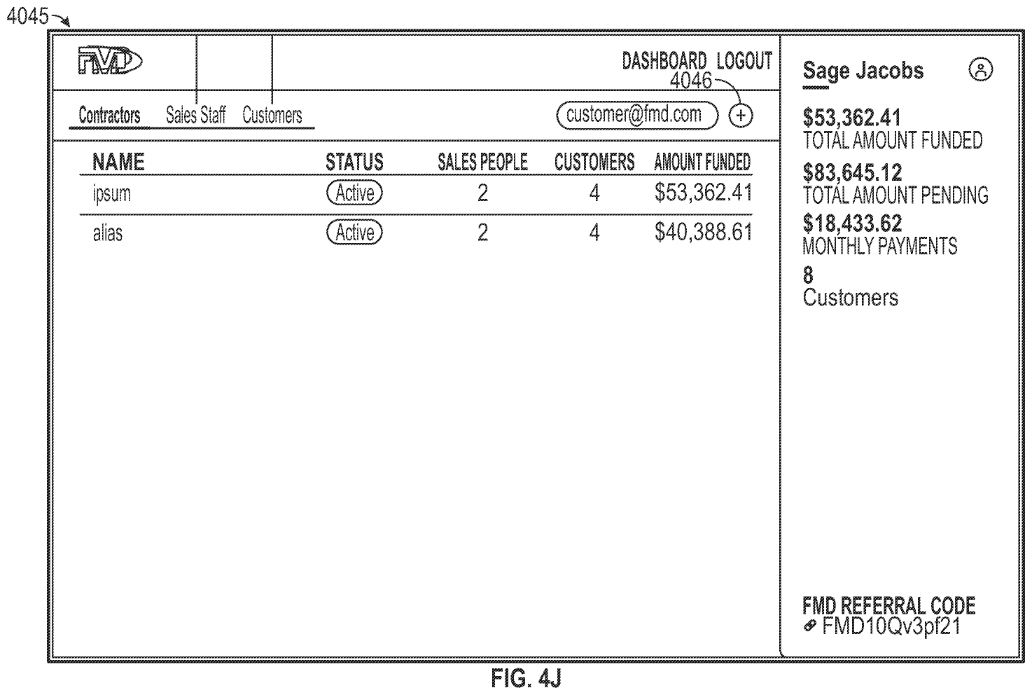

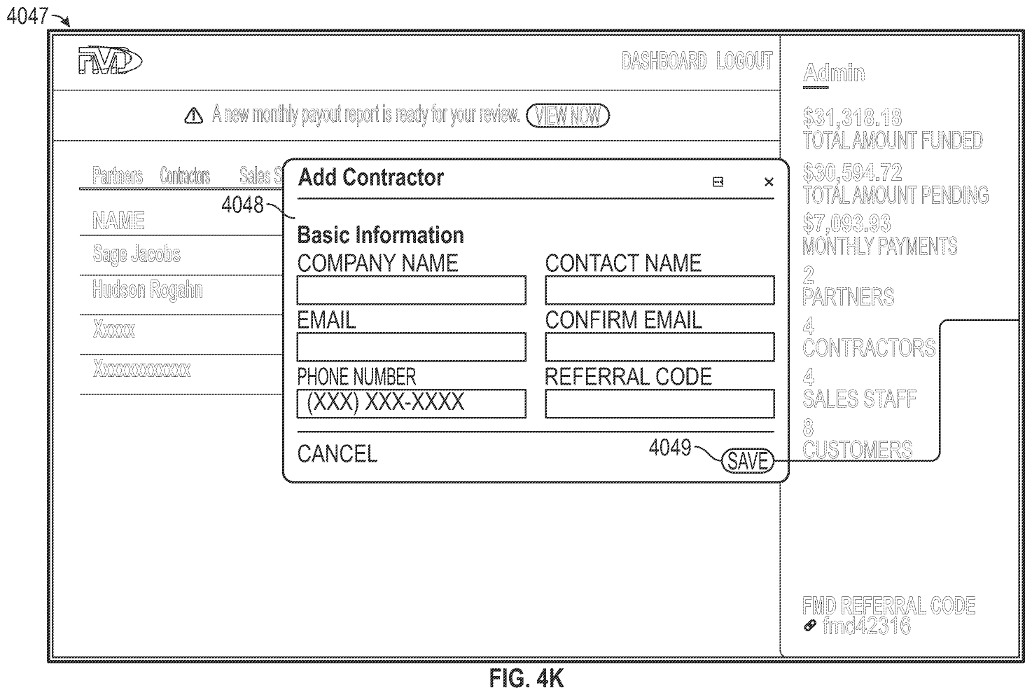

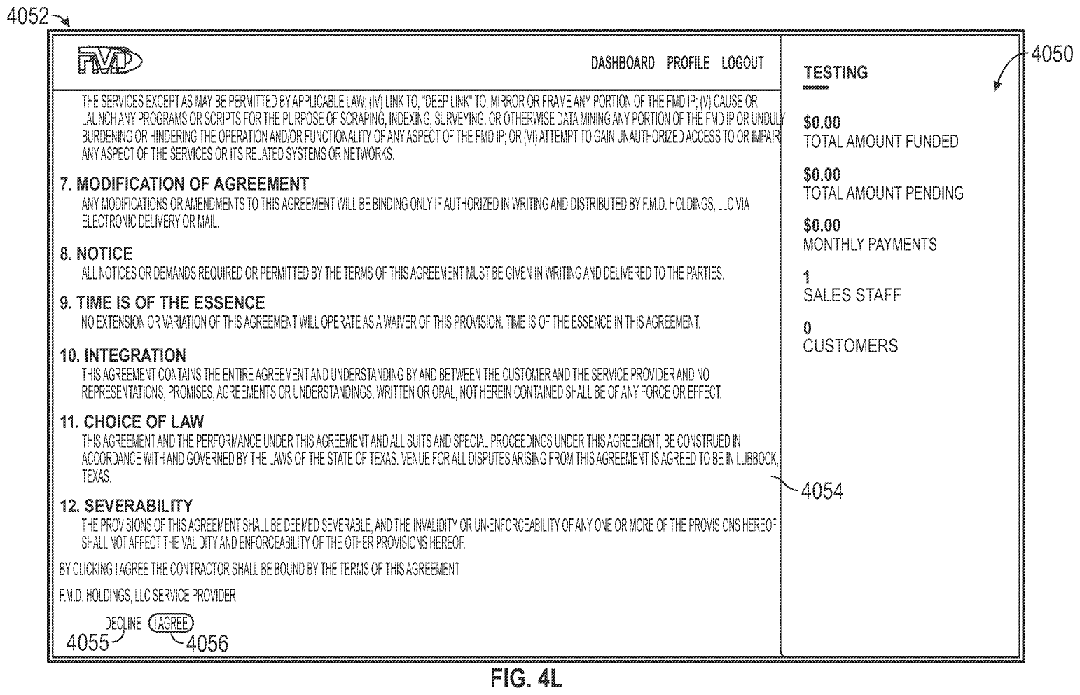

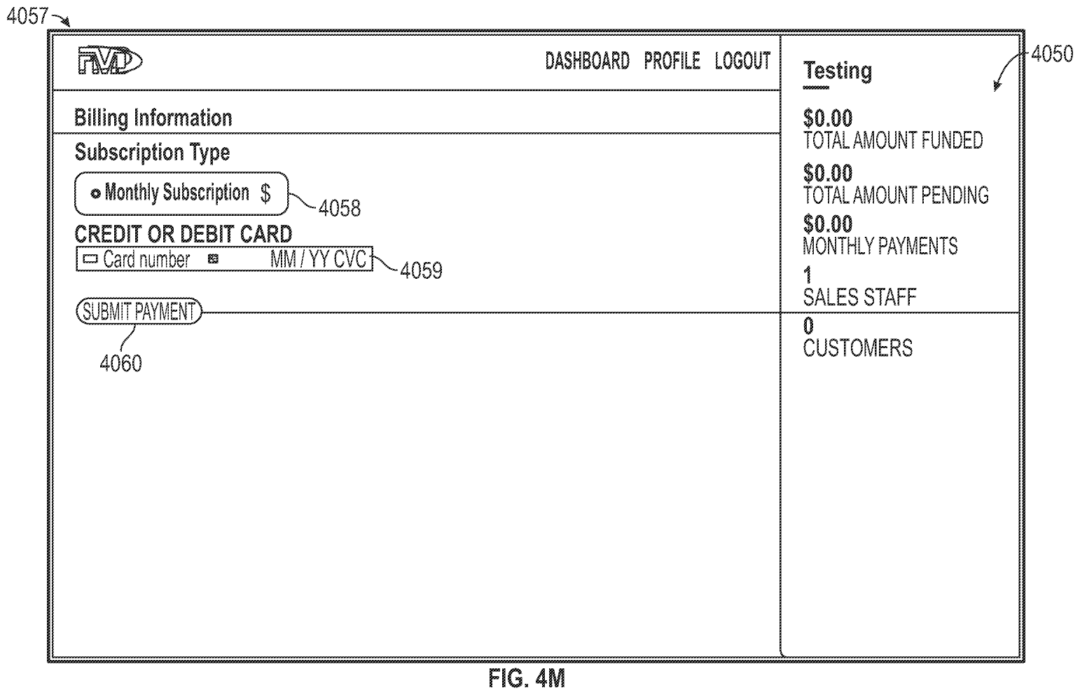

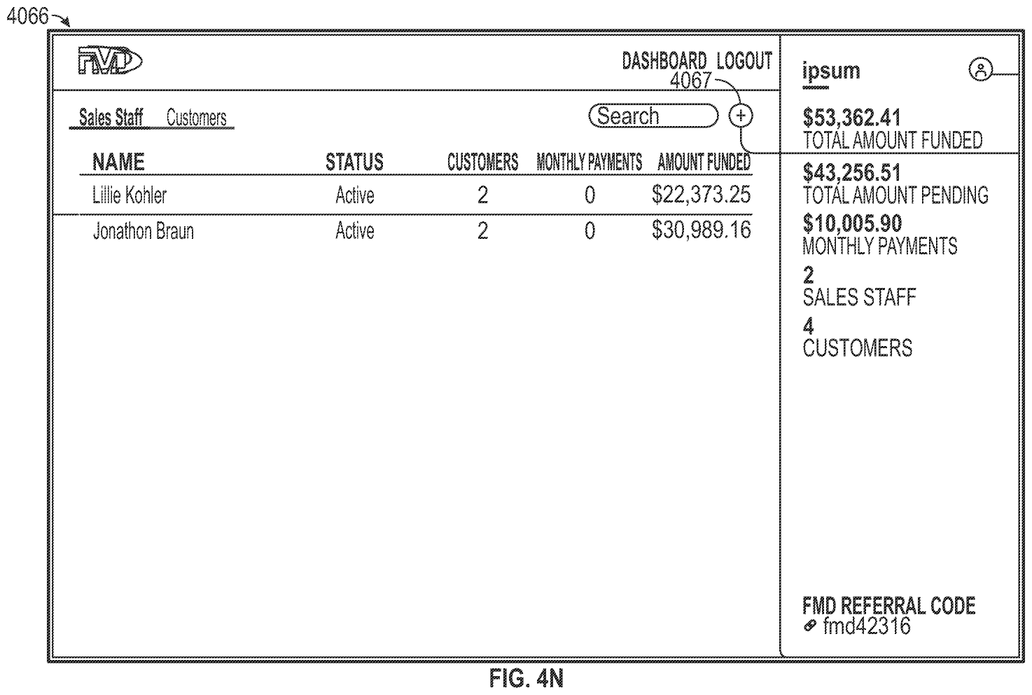

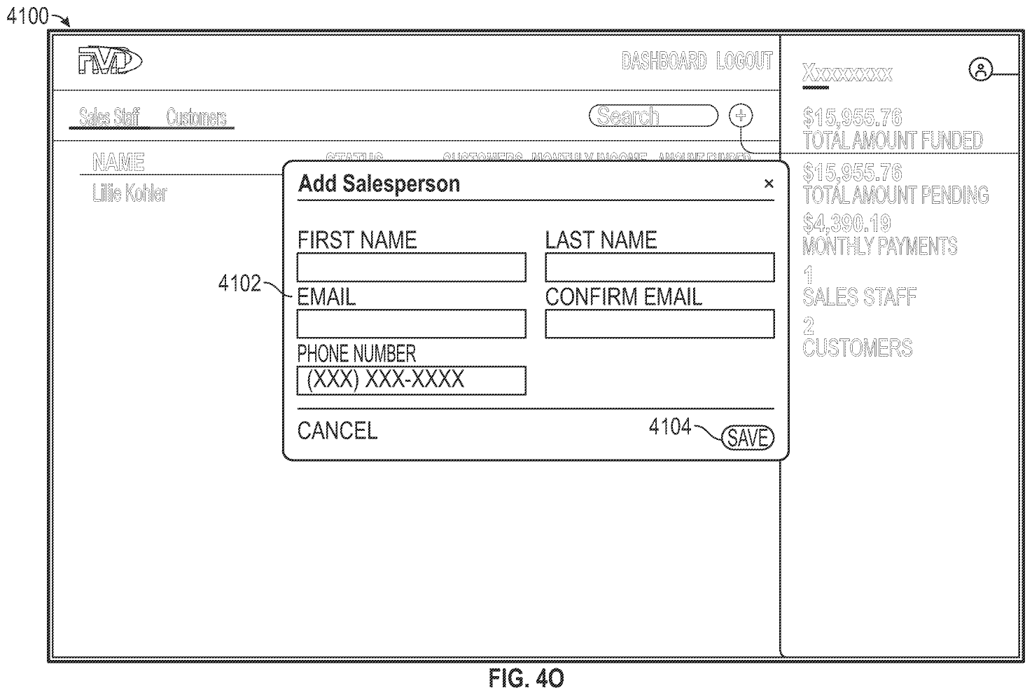

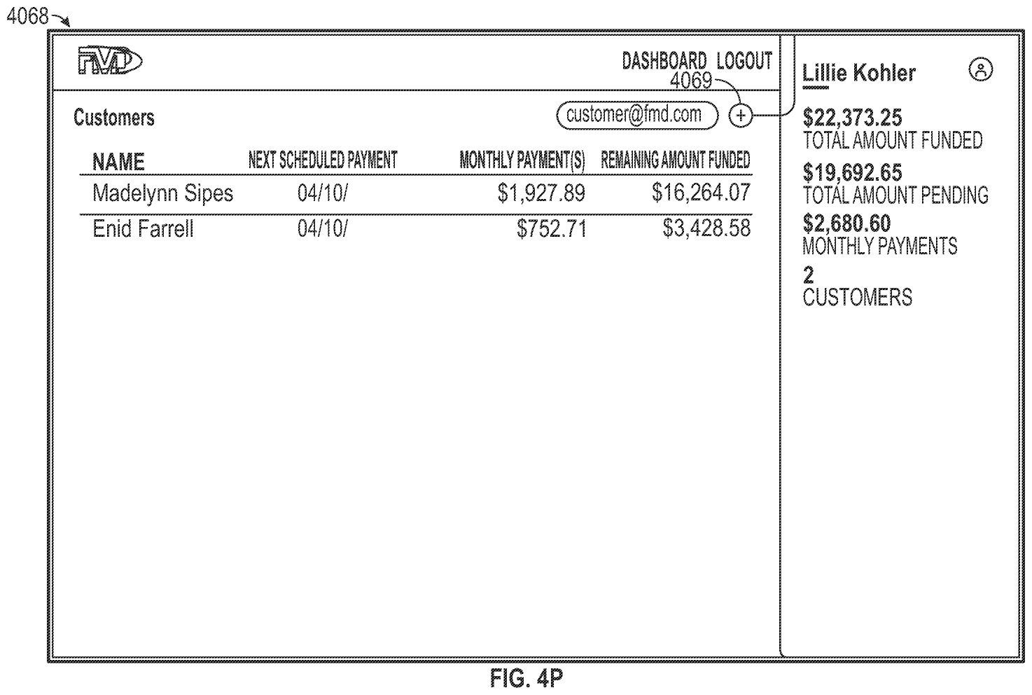

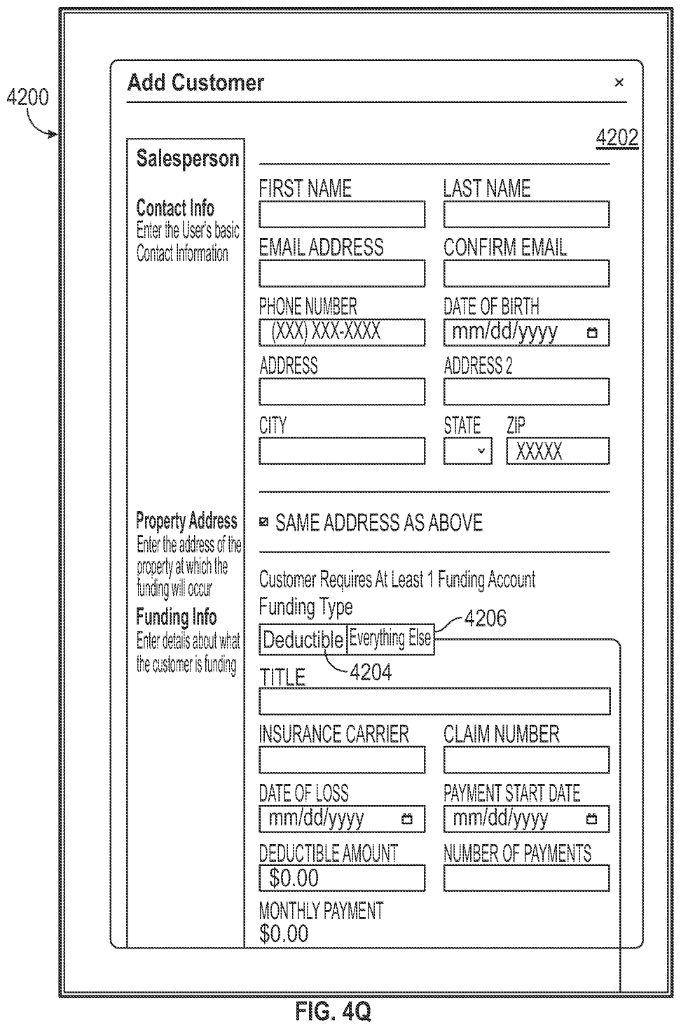

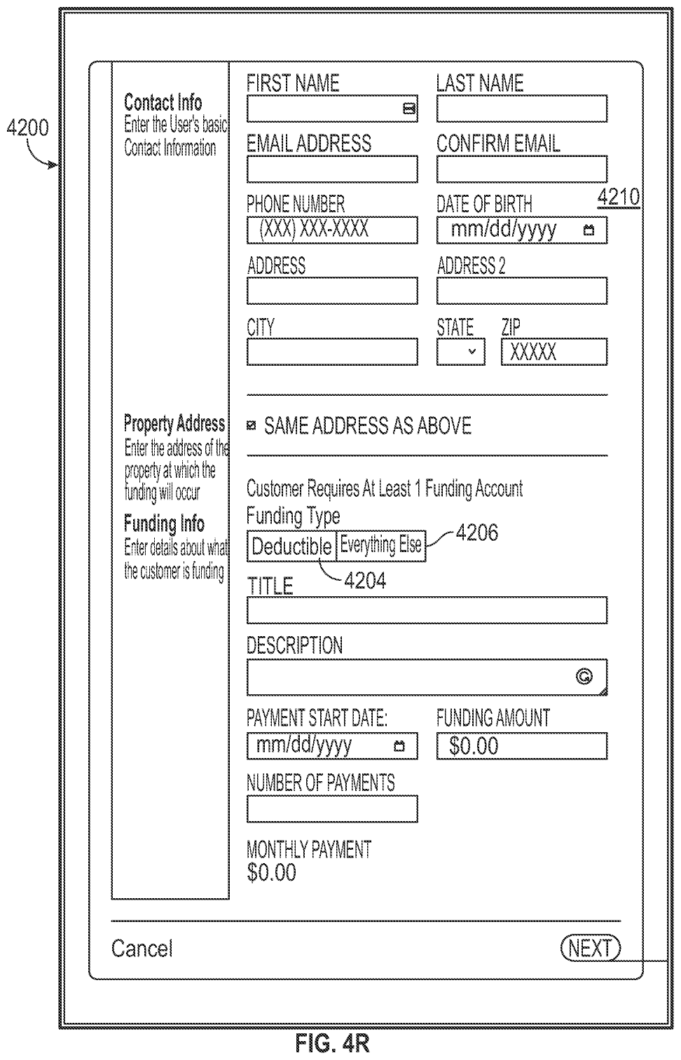

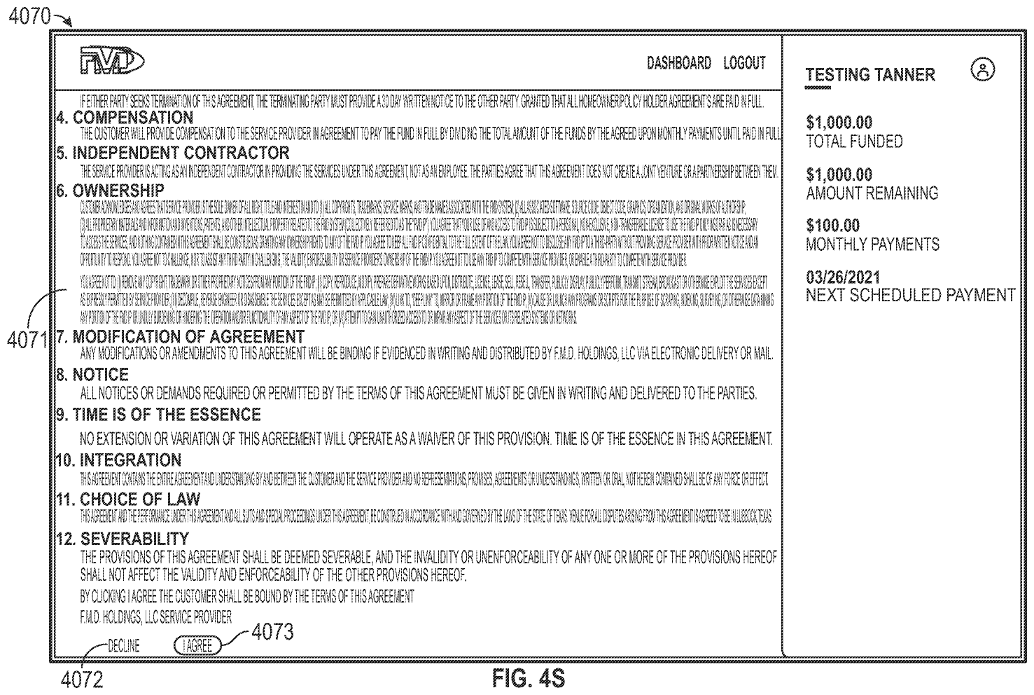

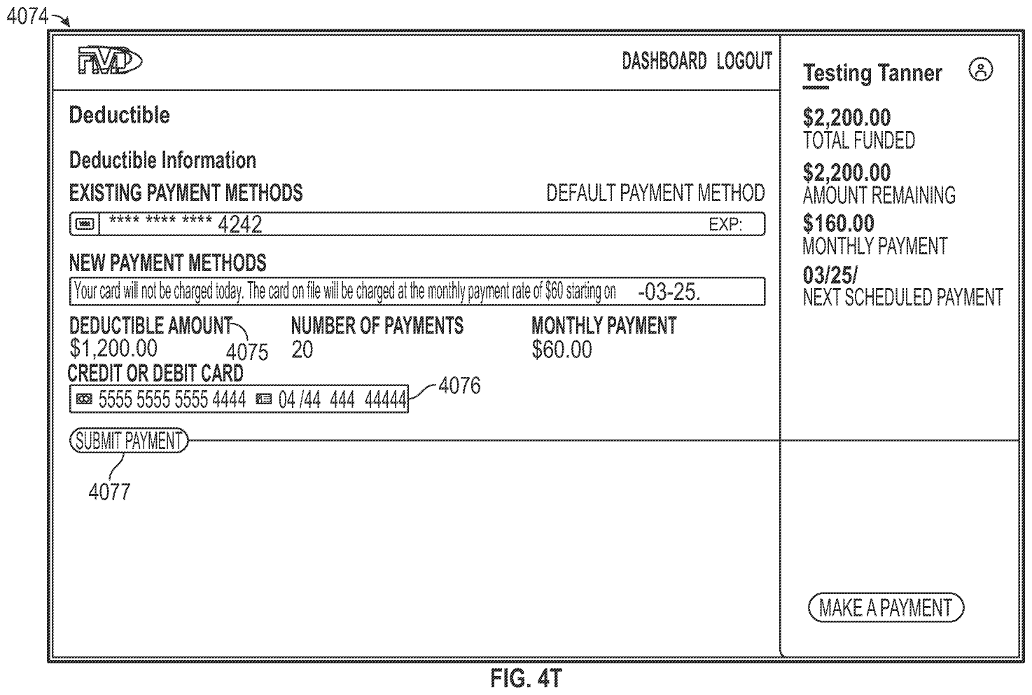

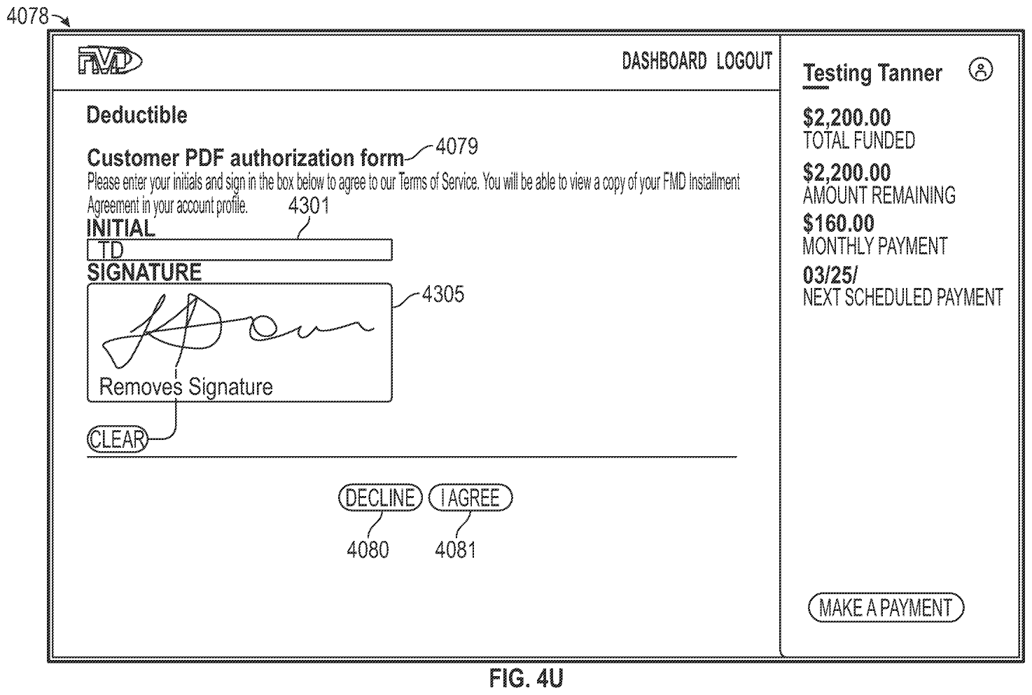

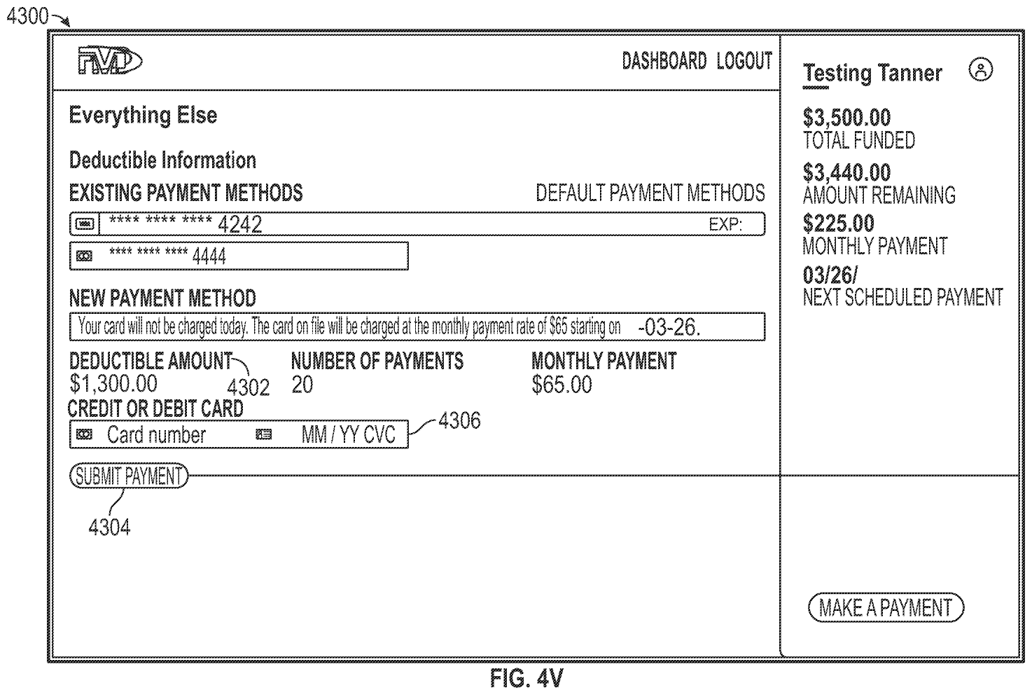

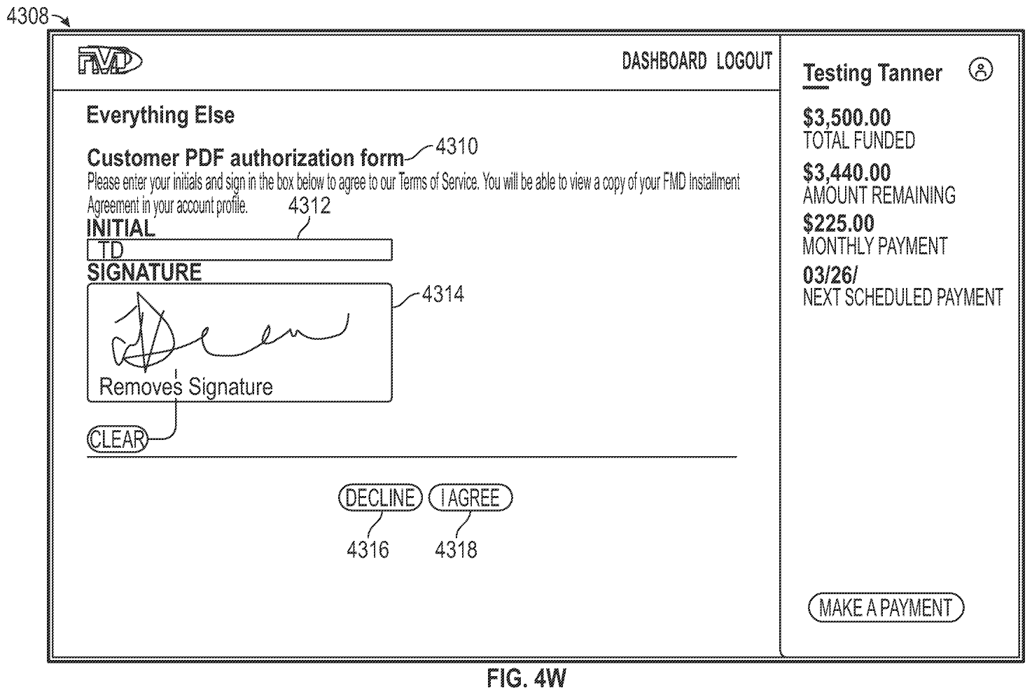

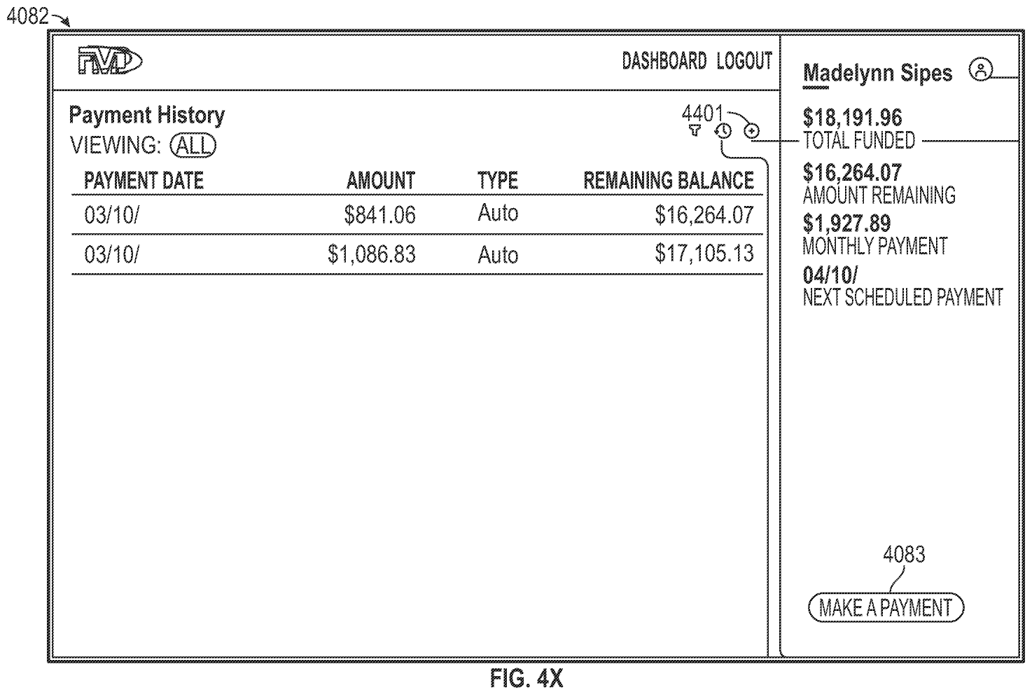

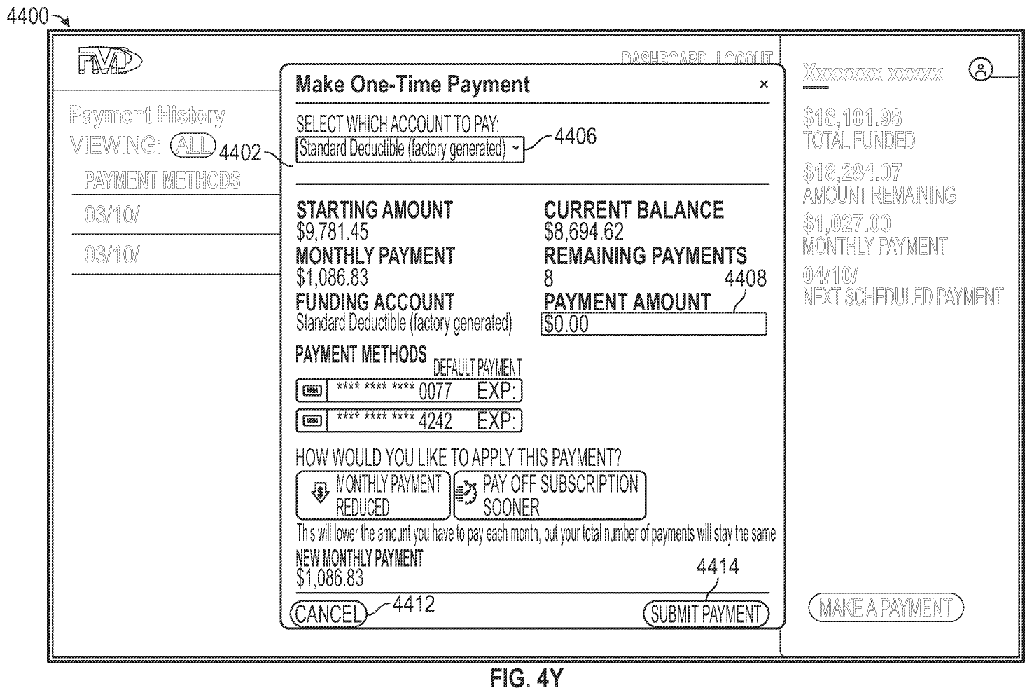

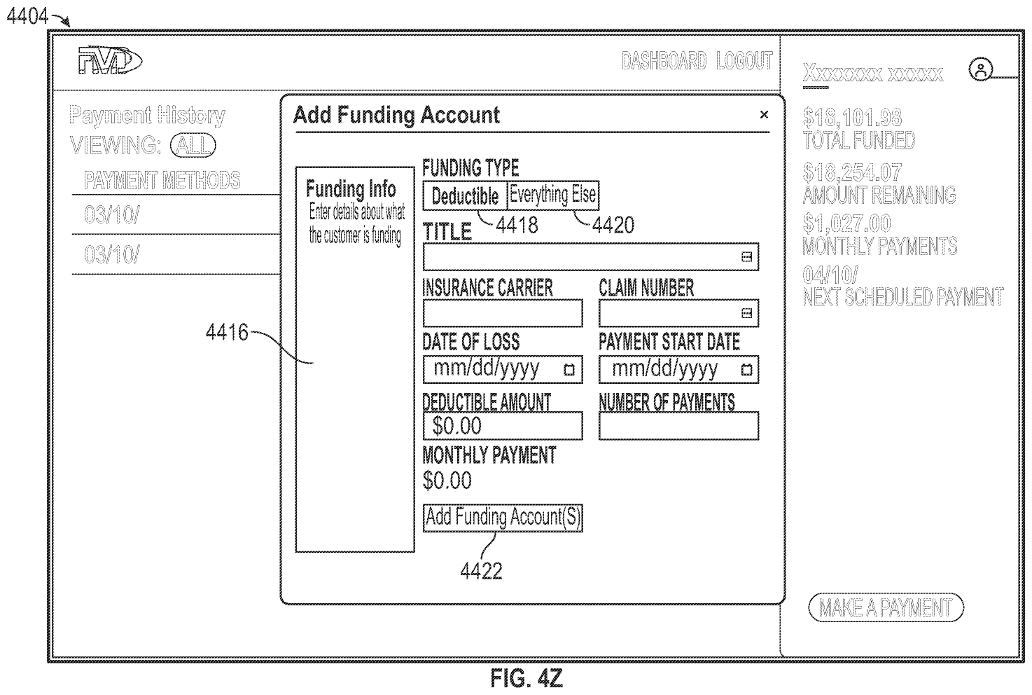

Referring then to FIGS. 4A-4Z a sequence for navigating a preferred embodiment of the system's graphic user interface will be described. In a preferred embodiment, a customer may have a deductible, another type of construction project, or both funded through the system. Any funded project not covered by insurance, such as an upgrade, renovation, or repair, is categorized as non-deductible, or “fund everything”, account.

Referring then to FIG. 4A, login screen 4016. Here login credentials are input into email text box 4017 and password textbox 4018, and login button 4020 is selected. If the user's login credentials are incorrect, an error message will appear requesting reentry of login credentials. If the login credentials are correct, the sequence proceeds to a segmented view dependent upon account type. In a preferred embodiment, there are five (5) types of user accounts: admin, partner, contractor, salesperson, and customer, as will be further described.

Alternatively, login screen 4016 includes forgot password link 4019. If a selection of forgot password link 4019 is made, the sequence proceeds to forgot password screen 4013.

Referring then to FIG. 4B, forgot password screen 4013 includes email text box 4014 and reset password button 4015. When a password reset request is submitted, the system sends an email with a password reset link, as shown in reset notification screen 4010.

Referring then to FIG. 4C, reset notification screen 4010 shows an exemplary email which includes forgot password message 4011, and reset password link 4012. When reset password link 4012 is selected, the link redirects the user to reset password screen 4007.

Referring then to FIG. 4D, reset password screen 4007 includes password reset form 4008 and save password button 4009. Password reset form 4008 requires a user to enter their email address and a new password and confirm the new password. When save password button 4009 is selected the system saves the new password and the sequence returns to login screen 4016.

Referring then to FIG. 4E, when administrator login credentials are entered on screen 4016, the sequence proceeds to administrator dashboard 4032. The administrator dashboard allows an administrator to view and add partners, contractors, sales staff, and customers from the various tabs and dashboards accessible to administrators, as will be further described. When add partner button 4033 is selected on the partner tab, the sequence proceeds to add partner screen 4034.

Referring then to FIG. 4F, add partner screen 4034 includes form 4035 and add partner button 4036. A partner is a third-party agent, such as a broker, who works with multiple contractors. The partner enlists contractors in the system and in return earns a percentage of the overall amount funded and the subscription fees for all the contractors the partner signs up. A partner may earn different percentages for deductible accounts versus non-deductible accounts. The partner's percentage of subscription fees, and the amount of the contractor subscription fees may be increased or decreased for each partner. A lower contractor monthly fee may incentivize contractors to signup through a specific partner for a lower subscription rate. Whereas, a higher rate may increase partner profitability and incentivize partner acquisition of new contractors.

Form 4035 includes text boxes where partner details are input, such as name, email, and phone number, as well as details about the partner's commission from funding agreements and subscriptions. In alternate embodiments, more or less information may be required to add a partner. After the required partner details are entered and add partner button 4036 is selected, the system sends an invitation email, as shown in notification screen 4037.

Referring then to FIG. 4G, notification screen 4037 includes invitation message 4039 and link 4038. When link 4038 is selected, the sequence redirects the user to create password screen 4029 shown in FIG. 4H. Screen 4029 includes password creation form 4030 and create account button 4031. After a password is entered and create account button 4031 is selected, the sequence proceeds to login screen 4016 shown in FIG. 4A.

The first-time partner login credentials are entered, the system displays payout account setup screen 4040 shown in FIG. 4I. Screen 4040 includes setup payout account button 4041. When button 4041 is selected, the sequence proceeds to a payment details screen (not shown). The payment details screen includes text boxes where account details must be entered to receive payments, such as country, entity type, mobile number, and email. In a preferred embodiment, payments are processed through Stripe®. However, it should be appreciated that alternate payment processing means may be used. Once a payout account is setup, the sequence directs a user with partner credentials to partner dashboard 4045.

Referring then to FIG. 4J, partner dashboard 4045 allows partners to view and add contractors, and view sales staff and customer details, as will be further described. The partner dashboard includes add contractor button 4046. The sequence proceeds to add contractor details screen 4047 when add contractor button 4046 is selected.

Referring then to FIG. 4K, screen 4047 includes form 4048 and save button 4049. Form 4048 includes text boxes where contractor details must be entered, such as company name, contact name, email address, phone number, and referral code must be entered. When save button 4049 is selected, the system sends an invitation email to the contractor, as shown in notification screen 4037, and account creation is completed as previously described.

Referring then to FIG. 4L, the first-time contractor login credentials are entered, the system displays terms of service screen 4052. Screen 4052 includes service agreement 4054 and funding summary bar 4050. The funding summary bar include the total amount funded, pending, expected monthly payments, number of sales staff and customers. The service agreement includes decline button 4055 and agree button 4056. When agree button 4056 is selected, the sequence proceeds to billing screen 4057.

Referring then to FIG. 4M, billing screen 4057 includes subscription options 4058, credit card text box 4059, and submit payment button 4060. Screen 4057 also includes summary bar 4050, as previously described. In a preferred embodiment, a contractor may select either an annual subscription for access to the system, or monthly subscription for access to the system. The system may also allow an administrator to enroll a contractor in a 30-day trial. However, it should be appreciated that various subscription and trial terms may be offered, such as quarterly, or semi-annually.

When submit payment button 4060 is selected, the sequence proceeds to payout account setup screen 4040 to enter payment details, as previously described. Once payment details are entered, the sequence proceeds to contractor dashboard 4066.

Referring then to FIG. 4N, contractor dashboard 4066 includes a sales staff tab and customer tab which allow contractors to view customer and staff details, as well as add sales staff and customers, as will be further described. Dashboard 4066 includes add button 4067 on the sales staff tab. When button 4067 is selected the sequence proceeds to add salesperson screen 4100.

Referring then to FIG. 4O, add salesperson screen 4100 includes form 4102 and save button 4104. Form 4102 includes text boxes for salesperson details, such as name, email, and phone number. Once the details are submitted and save button 4104 is selected, the system sends an invitation email and account creation is completed as previously described.

When salesperson login credentials are entered on login screen 4016, the system displays salesperson dashboard 4068 as shown in FIG. 4P. Salesperson dashboard 4068 includes add button 4069 and allows salesmen to view and add customer details, as will be further described. When button 4069 is selected, the sequence proceeds to add customer screen 4200.

Referring then to FIG. 4Q, add customer screen 4200 includes form 4202, deductible button 4204, and everything else button 4206. In form 4202, deductible button 4204 is selected. When the deductible button is selected the form includes text boxes for customer details, such as name, phone number, email address, home address, as well as insurance policy claim details, such carrier, claim number, date of property loss/damage, deductible amount, funded amount, and number of payments. For non-deductible funding agreements, a selection of everything else button 4206 presents form 4210.

Referring then to FIG. 4R, when button 4206 is selected form 4210 includes text boxes for customer details, such as name, phone number, email address, home address, as well as a description of the service being funded, funded amount, and number of payments.

Once the customer details are submitted, the system sends an invitation email to the customer and account creation is completed as previously described.

Referring then to FIG. 4S, when customer login credentials are entered for the first time, the system displays terms of service agreement screen 4070. Screen 4070 includes service agreement 4071, decline button 4072, and agree button 4073. When agree button 4073 is selected, the sequence proceeds to either billing screen 4074 or billing screen 4300, as will be further described.

Referring then to FIG. 4T, when deductible customer login credentials are entered for the first time after executing a new agreement, billing screen 4074 is displayed after terms of service are accepted. Billing screen 4074 includes payment plan overview 4075, submit payment button 4077, and text box 4076 where credit card information is entered for the initial payment. After the initial payment is made, the sequence proceeds to signature screen 4078.

Referring then to FIG. 4U, signature screen 4078 includes authorization form link 4079, decline button 4080, and agree button 4081. The authorization form provides the details of the policy holder and insurance policy, which is used to verify the payment of the deductible for the insurance company. The link may be selected to view the form. Screen 4078 also includes initial text box 4301, and signature box 4304. The agree button is not activated if boxes 4301 and 4304 are not filled in. When button 4081 is selected, the system applies the signature and initials to the authorization form, and the sequence proceeds to customer dashboard 4082.

Alternatively, when a non-deductible customer login credentials are entered for the first time after executing a new funding agreement, the system displays billing screen 4300 after terms of service are selected. Referring then to FIG. 4V, billing screen 4300 includes payment plan overview 4302, submit payment button 4305, and text box 4306 where credit card information is entered for the initial payment. After the initial payment is made, the sequence proceeds to signature screen 4308.

Referring then to FIG. 4W, signature screen 4308 includes authorization form link 4310, decline button 4316, agree button 4318, initial text box 4312, and signature box 4314, as previously described. The agree button is not activated if boxes 4312 and 4314 are not filled in. When button 4318 is selected, the system applies the signature and initials to the authorization form, and the sequence proceeds to customer dashboard 4082.

Referring then to FIG. 4X, customer dashboard 4082 includes make payment button 4083, add button 4401, and allows the customer to view their agreements, make payments, view a payment plan summary bar, and view payment history, such as the date of payment, payment amount, type of payment, and remaining balance, as will be further described. When add button 4401 is selected, the sequence proceeds to add funding account screen 4404, as will be further described. When make payment button 4083 is selected, the sequence proceeds to payment screen 4400.

Referring then to FIG. 4Y, payment screen 4400 includes payment form 4402. Payment form 4402 includes account drop-down 4406, payment amount box 4408, cancel button 4412, and submit button 4414. The payment form also includes a summary of the selected account such as initial amount funded, current balance, account type, remaining payments, and monthly payment amount. When additional payments are made, a user may select to have the amount applied to the overall amount owed, or to a single payment.

Referring then to FIG. 4Z, add funding account screen 4404 includes account form 4416 with deductible type button 4418, non-deductible type button 4420, and add funding account button 4422. Account form 4416 allows a customer to select one or more funding accounts to request. In form 4416, deductible type button 4418 is selected. When deductible type button 4418 is selected the form requests insurance policy information, such as carrier, claim number, date of damage, payment start date, deductible amount, and number of payments, with a monthly payment indicator. When non-deductible type button 4420 is selected the form requests service description, payment start date, funded amount, and number of payments, with a monthly payment indicator. When add funding account button 4422 is selected, the request is submitted to the system for review and approval, and the sequence returns to customer dashboard 4082.

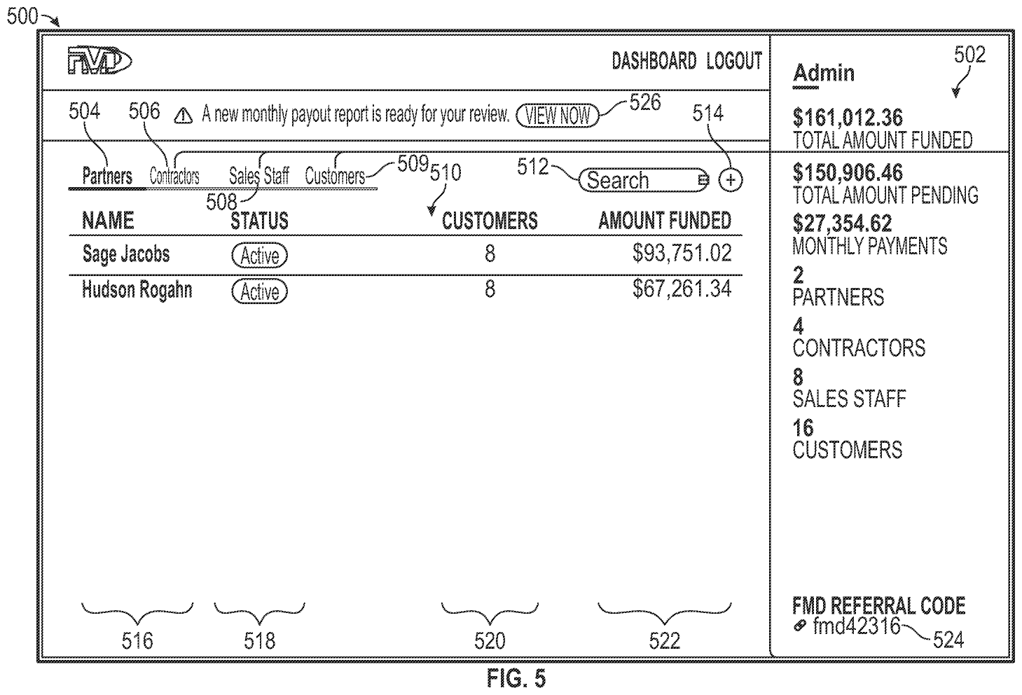

Referring then to FIG. 5, a graphic user interface displaying administrator dashboard 500 is described.

Administrator dashboard 500 includes summary bar 502 which provides an overview of the number of partner, contractors, sales staff, and customers, the total amount funded, the total amount of funding pending, and the month payments. Administrator dashboard 500 also includes partner tab 504, contractors tab 506, sales staff tab 508, and customers tab 509. In dashboard 500, partner tab 504 is selected. When partner tab 504 is selected, the dashboard shows partner list 510, search bar 512, and add button 514. When other tabs are selected similar lists of the users in that category and an add button for the type of user are displayed. Partner list 510 includes name column 516, status column 518, customers column 520, and funded column 522. The system allows administrators to delete or view the dashboard and details of any individual user by selecting an account from the list. Administrators may also send an invitation email to any type of user by selecting the appropriate add button. Similarly, administrators may share referral code 524 with a potential user. The referral code link may be emailed or copied.

Dashboard 500 further includes report button 526. Button 526 is for a monthly payout report generated by the system. The report includes accounting details such as profits, payments received, unprocessed payments, late payments, and commission amounts broken down by partners and contractors. The report also provides a list of partner and contractor payouts that are pending. An administrator may approve payouts and issue full or partial refunds to contractors.

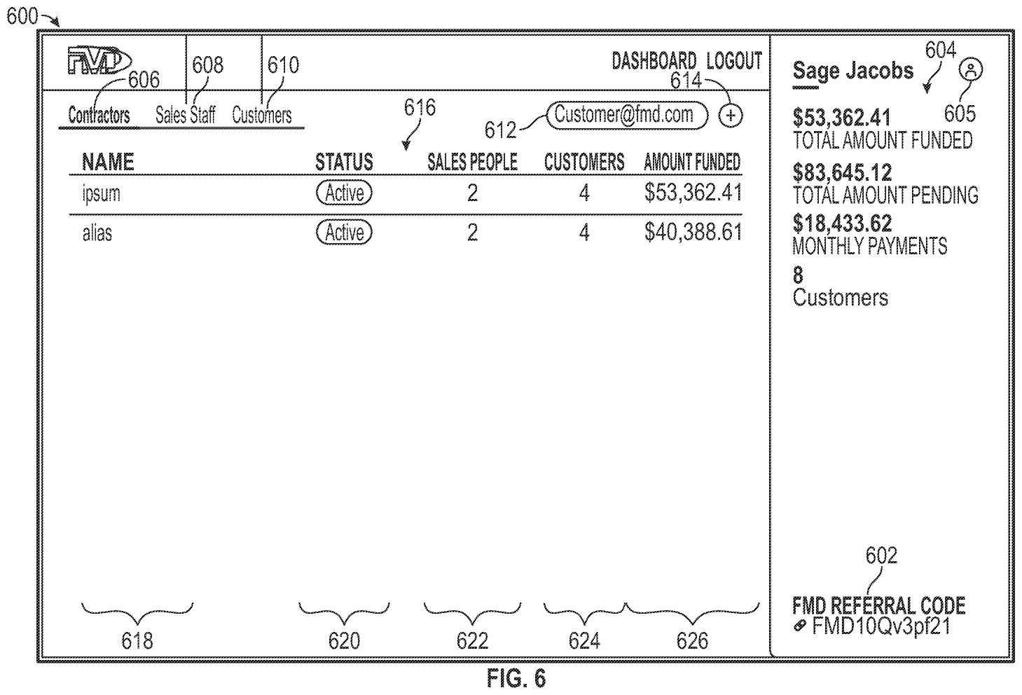

Referring then to FIG. 6, a partner graphic user interface is shown displaying partner dashboard 600.

Partner dashboard 600 includes summary bar 604 and referral code 602. Summary bar 604 provides an overview of the number of customers, the amount funded, the monthly payments amount, and the total pending funding. The summary bar also includes profile button 605. When selected, the system displays a pop-up partner profile. The partner profile lists contact information and commissions settings. The commissions settings include fee arrangements, such as the percentage received from customer deductibles, customer fund everything, and monthly contractor and subscription fees. A partner may update contact information, but only administrators may adjust the commissions settings.

Summary bar 604 also includes referral code 602. Referral code 602 may be shared with contractors, sales staff, and customers. Accounts created through a referral code are connected to the partner linked to the code. The referral code link may be emailed or copied for sharing.

Partner dashboard 600 also includes contractors tab 606, sales staff tab 608, and customers tab 610. In dashboard 600, contractors tab 606 is selected. When contractors tab 606 is selected, the dashboard shows contractor list 616, search bar 612, and add button 614. Contractor list 616 includes name column 618, status column 620, sales staff column 622, customer column 624, and funded column 626. When tab 608 is selected, a similar list of sales staff associated with the partner account is displayed. When tab 610 is selected, a similar list of customers associated with the partner account is displayed. The system allows partners to view the dashboard and details of linked contractors, sales staff, and customers by selecting an account. Partners may send an invitation email to contractors by selecting add button 614, as previously described.

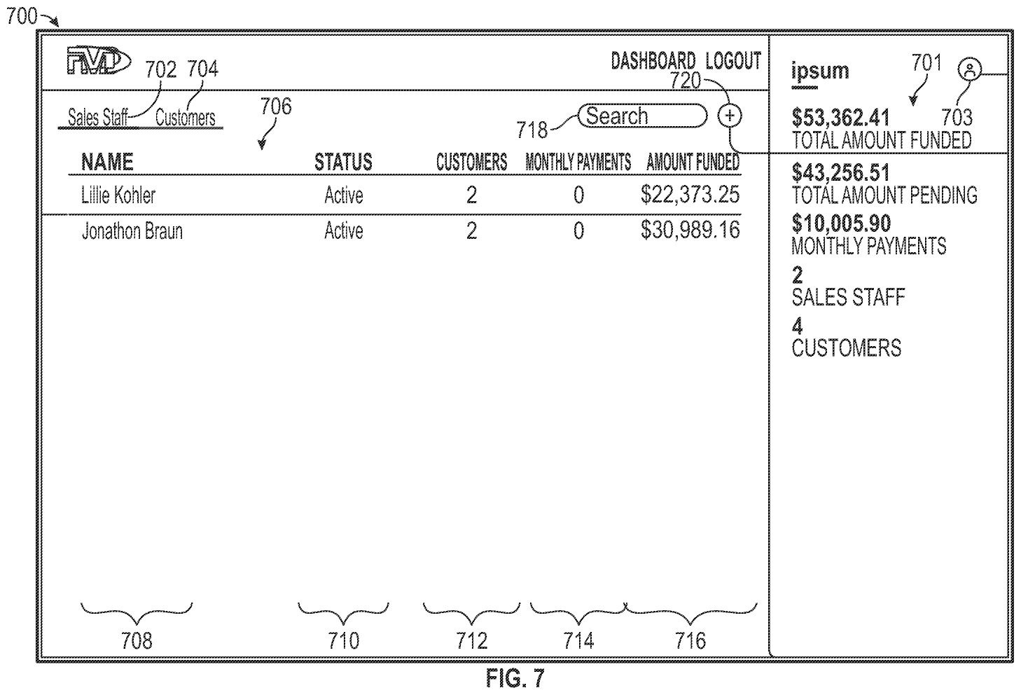

Referring then to FIG. 7, a contractor graphic user interface is shown displaying contractor dashboard 700.

Contractor dashboard 700 includes summary bar 701. Summary bar 701 provides an overview of the number of customers, number of staff, the month payments, the amount of pending funds, and the total amount funded. The summary bar also includes profile button 703. When selected, the system displays a pop-up contractor profile. The contractor profile lists contact information, subscription settings, and payment information. A contractor may update contact and payment information.

Contractor dashboard 700 also includes sales staff tab 702 and customers tab 704. In dashboard 700, sales staff tab 702 is selected. When sales staff tab 702 is selected, the dashboard shows sales staff list 706, search bar 718, and add button 720. Sales staff list 706 includes name column 708, status column 710, customer column 712, monthly payments column 714, and funded column 716. When tab 704 is selected, a similar list of customers associated with the contractor account is displayed. The system allows contractors to view the dashboard and details of linked sales staff, and customers by selecting an account. Contractors may send an invitation email to sales staff and customers by selecting the add button in tab 702 or 704, respectively.

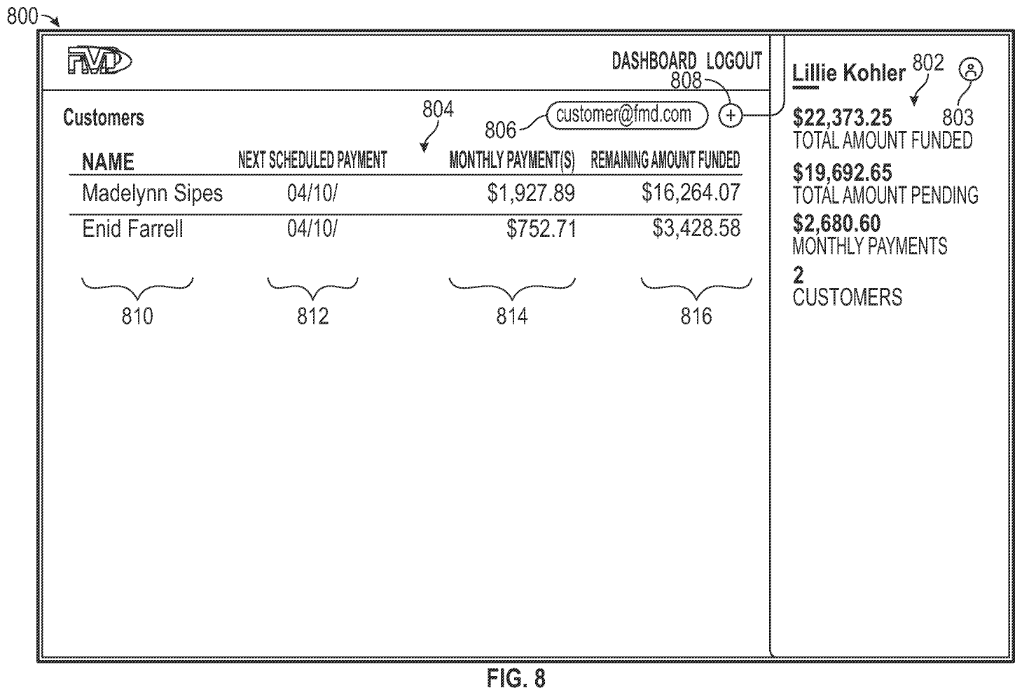

Referring then to FIG. 8, a sales staff graphic user interface is shown displaying sales staff dashboard 800.

Dashboard 800 includes summary bar 802. Summary bar 802 provides an overview of the number of customers, the monthly payments, the amount of pending funding, and the total amount funded. The summary bar also includes profile button 803. When selected, the system displays a pop-up sales profile. The sales profile lists contact information, such as name and phone number. A salesperson may update contact information.

Sales staff dashboard 800 also includes customer list 804, search bar 806, and add button 808. Customer list 804 includes name column 810, next scheduled payment 812, monthly payments column 814, and remaining amount column 816. In an alternate embodiment, customer list 804 also includes a column for the type of funding, such as deductible, other, or both, as previously described. The system allows sales staff to view the dashboard and details of linked customers by selecting the account. Sales staff may send an invitation email to customers by selecting add button 808.

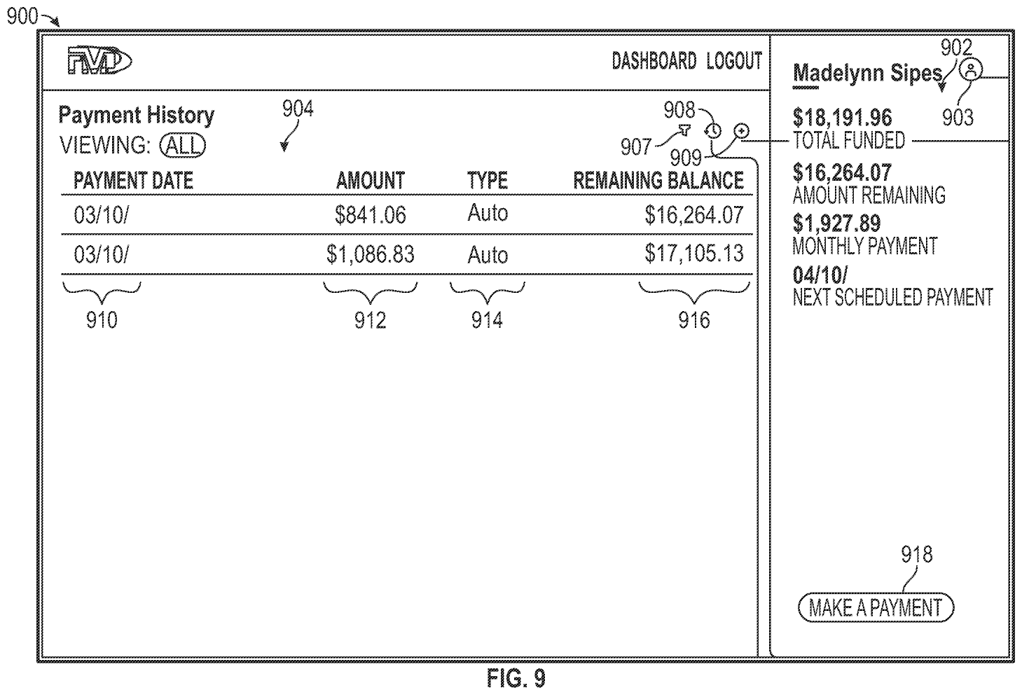

Referring then to FIG. 9, a customer graphic user interface is shown displaying customer dashboard 900.

Dashboard 900 includes summary bar 902. Summary bar 902 provides an overview of the customer account, including total funded amount, remaining amount, monthly payments, and next payment date. The summary bar also includes profile button 903. When selected, the system displays a pop-up of the customer profile. The customer profile includes customer contact information, account information, and payment methods. The customer may edit contact and payment methods.

Customer dashboard 900 also includes payment history list 904, filter 907, document history button 908, add funding button 909, and make payment button 918. Payment history list 904 includes date column 910, amount column 912, type column 914, and remaining amount column 916. Payment history list provides an overview of all the payments made on the funding agreements. Under type column 914, a customer may determine if the payment was made through automatic deposit or manually. In a preferred embodiment, when a customer has multiple types of funding agreements, type column 914 will also include an indication of the fund the payment was applied to, such as “deductible” or “everything”. Customers may view any current or previous documents by selecting document history button 908. Customers may request additional funding by selecting add funding button 909 or make additional payments by selecting make payment button 918, as previously described.

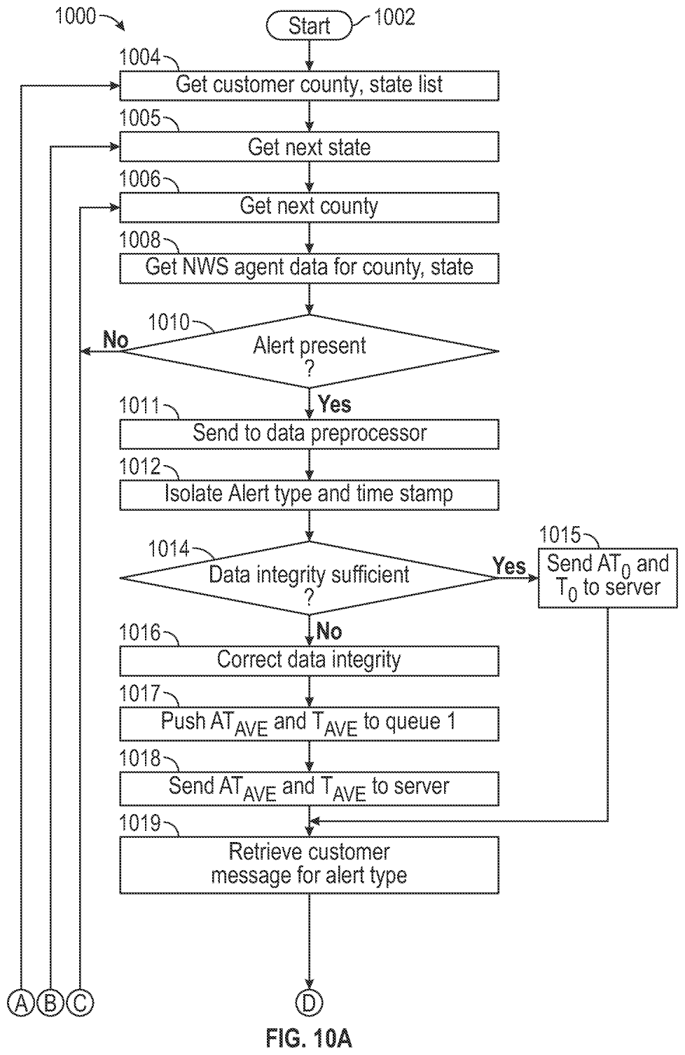

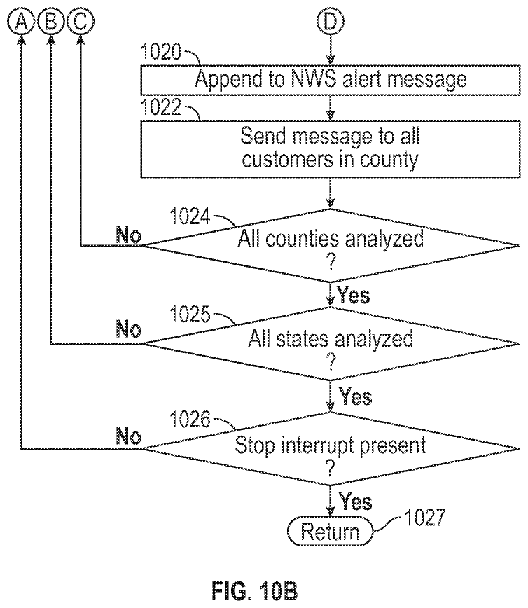

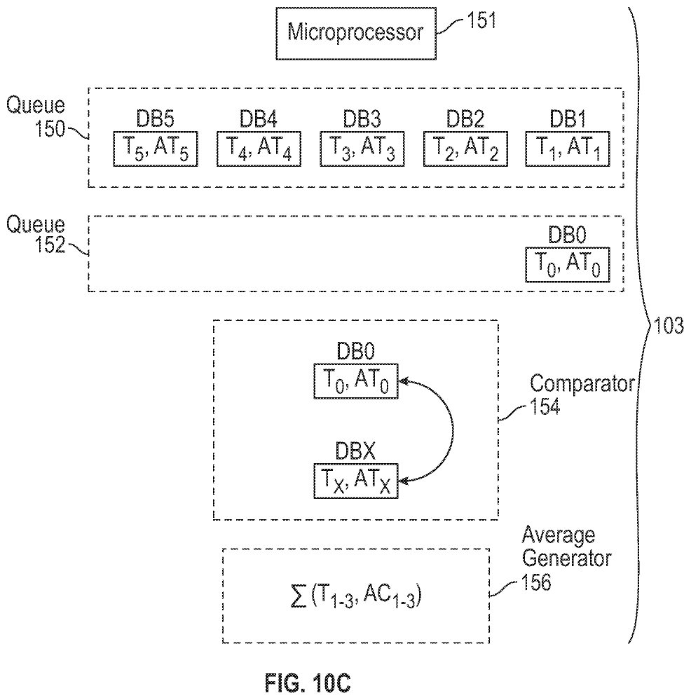

Referring to FIGS. 10A and 10B, method 1000 for sending alert messages will be further described. Data preprocessor 103, as well as server 104 should be booted and running when the method begins.

Preferably, method 1000 takes the form of cooperating software programs written in Python, running on server 104 and microprocessor 151, and which work in unison to receive and preprocess data from weather data processor 105 and send messages to select client devices 112 connected to the system.

At step 1002, the method begins.

At step 1004, server 104 retrieves a list of customers from database 106, listed by state and by county of residence.

At step 1005, server 104 advances to the next state in the list.

At step 1006, server 104 advances to the next county in the list.

At step 1008, server 104 activates an API to retrieve United States National Weather Service (NWS) weather alert data for the county and the state. Preferably, server 104, acting as an endpoint, generates an API request to weather data processor 105 in GeoJSON format. The API request is generated once every five minutes. Other time periods may be used. JSON-LD, DWML, OXML, CAP and ATOM formats may also be used. Other weather data sources besides NWS may be used.

The API call uses linked data to discover alert content related to “watch” and “warning” advisories based on geolocation zones or by state and county. Preferably, the API makes a call to retrieve county-based data, which indicates one of eight warning conditions according to the Universal Geographic Code (UGC). UGC contains two letter state abbreviations and a single letter county designations. Currently, the eight warning conditions are available in the watch and warning advisories are “severe thunder warning,” “tornado warning,” “flash flood warning,” “special marine warning,” “snow squall warning,” “dust storm warning,” “dust storm advisory,” and “extreme wind warning.” A geocode property is returned from the API which includes a county designation including a list of affected zones and an “event” type along with a “severity” indicator, a “certainty” indicator, and an “urgency” indicator.

Integrity issues with the data resulting from the API call to the NWS are pervasive. Common integrity issues include availability of the data, irregular or missing, timestamp data, and consistency in alert types. The integrity issues in the data, or “discontinuities” must be corrected before the data may be dependably used, as will be further described.

At step 1010, the server determines whether or not an alert is present for the given county and state. If so, method proceeds to step 1011. If not, the method returns to step 1006.

At step 1011, the server sends the alert in a JSON alert packet, to the data preprocessor.

At step 1012, the data pre-processor isolates the alert type, and the timestamp from the alert packet. Preferably, the alert type is one of the eight previously described.

At step 1014, data preprocessor 103, determines whether or not the alert packet is of sufficient integrity. If so, the method proceeds to step 1015. If not, the method proceeds to step 1016.

At step 1015, microprocessor 151 sends AT₀ and T₀ to the server.

Referring also to FIG. 10C, in a preferred embodiment, to determine whether or not the data packet is of sufficient integrity, data preprocessor 103 compares the timestamp, and the alert type, of the current alert packet to the previous five alert packets. In general, if an event type is missing, or inconsistent, or if the timestamp is more than 15 minutes from the prior timestamp, or is missing, then the data is considered to be of insufficient integrity. If not, the data is considered to be of sufficient integrity.

Comparator 154 includes an identity comparator which is used to sequentially compare the current alert type AT₀, in data block 0, to each of the recent past alert types AT₁, AT₂, AT₃, AT₄ and AT₅ in each of data block 1, data block 2, data block 3, data block 4, and data block 5, in order, to determine whether or not the data is identical.

If all comparisons return true, then the data is identical and the comparator returns AT₀ to the microprocessor. If all three comparisons do not return true, then the data is not identical and the comparator returns the last three alert types, AT₀, AT₁ and AT₂ to the average generator.

Comparator 154 further includes a magnitude comparator which is used to sequentially compare T₀ to T₁, T₂, T₃, T₄, and T₅ to determine if T₀ is greater than any or all of the other time stamps in the data blocks by at least 15 minutes. By convention, T₁ is the most recent timestamp before T₀, followed by T₂, T₃, T₄, with T₅ being the oldest, or least recent, timestamp. If, in each case, T₀, is greater in magnitude than T₁, T₂, T₃, T₄, and T₅ for each of data blocks 1-5 (Tₓ), then comparator 154 passes T₀ to the microprocessor where it is used to determine a message type, as will be further described. If not, or if T₀ is missing, then T₁, T₂, and T₃ are passed to average generator 156 for further processing, as will be further described.

At step 1016, data preprocessor 103 corrects the integrity of the data. Average generator 156 receives as input alert types, AT₀, AT₁, and AT₂, and timestamps T₁, T₂, and T₃ from data block 1, data block 2, and data block 3, respectively, from comparator 154. The average generator then calculates an “average alert type” and an “average timestamp.”

The “average alert type”, ATₐᵥₑ, is either the most recent alert type, AT₀, if none of the alert types match, or, the alert type that occurs with the greatest frequency in alert types AT₀, AT₁, and AT₂, if two of the three alert types match. If AT₀ is missing AT₁ is passed to the microprocessor as ATₐᵥₑ.

The “average timestamp”, Tₐᵥₑ, must be calculated when T₀ is missing, or when T₀ is not greater than T₁, T₂, T₃, T₄, or T₅, by 15 minutes, and is calculated by the following equation.

$${T}_{ave} = {T}_{3} + \frac{{D}_{1} + {D}_{2}}{2}$$

Where:
Tₐᵥₑ=average timestamp;
T₁=second most recent timestamp;
D₁=difference between T₃ and T₂; and
D₂=difference between T₂ and T₁.

At step 1017, ATₐᵥₑ and Tₐᵥₑ are then pushed to queue 150, replacing AT₁ and T₁ and shifting the remaining alert types and timestamps further down the queue. AT₅ and T₅ are pushed out of the queue and deleted. At step 1018, microprocessor 151 sends ATₐᵥₑ and Tₐᵥₑ to the server.

At step 1019, server 104 retrieves a customer message type based on the alert type sent from by data preprocessor 103. Preferably, the customer message is drawn from a table stored in database 106. Table 1, shown below, is an example. Other message types may be used.

TABLE 1

| NWS Alert Type | Message Type |
|---|---|
| Severe Thunderstorm Warning | Roof Deductible Funding Product |
| | Vehicle Deductible Funding Product |
| Tornado Warning | Roof Deductible Funding Product |
| | Vehicle Deductible Funding Product |
| | Health Deductible Funding Product |
| Flash Flood Warning | Vehicle Deductible Funding Product |
| | Health Deductible Funding Product |
| Special Marine Warning | Boat Deductible Funding Product |
| Snow Squail Warning | Vehicle Deductible Funding Product |
| | Health Deductible Funding Product |
| Dust Storm Warning | None |
| Extreme Wind Warning | Roof Deductible Funding Product |

The funding product in each case provides a text file describing a deductible funding contract customized to the alert type, as previously described.

At step 1020, the customer message is appended to the alert type and the timestamp in a single outgoing message format. In another embodiment, the customer message and the alert type and timestamp are sent as two separate messages.

At step 1022, server 104 sends the outgoing message to all client devices for all customers in the current state and the current county stored in memory. In this way, each customer receives a high integrity warning of impending weather, along with the customer message. In another embodiment, the alert type and timestamp are sent immediately, and the customer message is sent after a predetermined time period, such as 72 hours. Other predetermined time periods may be used.

At step 1024, server 104 determines whether or not all counties have been analyzed for the state. If not, the method returns to step 1006. If so, the method proceeds to step 1025.

At step 1025, the server determines whether or not all states have been analyzed. If so, the method moves to step 1026. If not, the method returns to step 1005.

At step 1026, server 104 determines whether or not a stop interrupt is present. Preferably, a stop interrupt is generated by administrator device 124 and received by the server through a web interface. A stop interrupt may also be generated by push button 174 which is received by the microprocessor and forwarded to the server. If not, server 104 returns to step 1004. If so, the server moves to step 1027.

At step 1027, the method concludes.

1. A system for issuing weather alerts comprising:
a system server, having a first processor and a first memory, connected to a network;
a data preprocessor, having a second processor, operatively connected to a second memory, a set of data queues, a data comparator and an average generator, operatively connected to the system server;
a weather data processor, having a third processor and a third memory, connected to the system server, through the network;
a message receiver processor, having a fourth processor and a fourth memory, connected to the system server, through the network; and
the first memory, the second memory, the third memory and the fourth memory including a set of instructions that when executed cause the system to:
retrieve a customer location list;
retrieve an alert data message for a location from the customer location list;
determine a data integrity condition from the alert data message;
generate an alert type based on the data integrity condition;
determine a message type based on the alert type; and
send a message, based on the message type, to the message receiver processor.

2. The system of claim 1, wherein the alert type is at least one of a group of severe thunder warning, tornado warning, flash flood warning, special marine warning, snow squall warning, dust storm warning, dust storm advisory, and extreme wind warning.

3. The system of claim 1, wherein the alert data message is one of a group of GeoJSON, JSON-LD, DWML, OXML, CAP and ATOM.

4. The system of claim 1, wherein the data integrity condition is one of a timestamp error and an alert type error.

5. The system of claim 1, wherein the step of determining the data integrity condition further comprises:
detecting a missing time stamp and detecting a discontinuous alert type.

6. The system of claim 1, wherein the message type is related to an insurance deductible funding product.

7. The system of claim 6, wherein the insurance deductible funding product is one of a group of a roof deductible product, a vehicle deductible product, a health deductible product, and a boat deductible product.

8. The system of claim 1, wherein the step of determining the data integrity condition further comprises:
determining if the alert type is present in the alert data message.

9. The system of claim 1, wherein the second processor further comprises:
a first core, operatively connected to a second core.

10. The system of claim 9, wherein the data preprocessor further comprises:
a first data queue, of the set of data queues, operatively connected to the first core;
a second data queue, of the set of data queues, operatively connected to the first core;
the data comparator, operatively connected to the first data queue and the second data queue; and
the average generator, running on the first core, executing the steps of:
receiving a first data block set;
receiving a second data block set;
activating the data comparator to generate a comparison of one of a set of time stamps and a set of alert types from the first data block set and the second data block set;
generating an average time stamp from the set of time stamps; and
generating an average alert type from the set of alert types.

11. A method for issuing weather alerts comprising:
providing a system server, having a first processor and a first memory, connected to a network;
providing a data preprocessor, having a second processor, operatively connected to a second memory, a set of data queues, a data comparator and an average generator, operatively connected to the system server;
providing a weather data processor, having a third processor and a third memory, connected to the system server, through the network;
providing a message receiver processor, having a fourth processor and a fourth memory, connected to the system server, through the network; and
providing the first memory, the second memory and the third memory with a set of instructions carry out the steps of:
retrieve a customer location list;
retrieve an alert data message for a location from the customer location list;
isolate an alert type from the alert data message;
determine a data integrity condition from the alert data message;
correct a data integrity error based on the data integrity condition;
determine a message type based on the data integrity error; and
send a message, based on the message type, to the message receiver processor.

12. The method of claim 11, wherein the alert type is provided as at least one of a group of severe thunder warning, tornado warning, flash flood warning, special marine warning, snow squall warning, dust storm warning, dust storm advisory, and extreme wind warning.

13. The method of claim 11, wherein the alert data message is provided as one of a group of GeoJSON, JSON-LD, DWML, OXML, CAP and ATOM.

14. The method of claim 11, wherein the data integrity error is provided as one of a timestamp error and an alert type error.

15. The method of claim 11, wherein the step of determining the data integrity condition further comprises one of a group of:
detecting a discontinuous time stamp and detecting a discontinuous alert type.

16. The method of claim 11, wherein the message type is provided as an insurance deductible funding product.

17. The method of claim 16, wherein the insurance deductible funding product is provided as one of a group of a roof deductible product, a vehicle deductible product, a health deductible product, and a boat deductible product.

18. The method of claim 11, wherein the step of correcting the data integrity error further comprises one of a group of:
Generating an average timestamp and generating an average alter type.

19. The method of claim 11, wherein the step of providing the second processor further comprises:
a first core, operatively connected to a second core.

20. The method of claim 19, wherein the step of providing the data preprocessor further comprises:
providing a first data queue, of the set of data queues, operatively connected to the first core;
providing a second data queue, of the set of data queues, operatively connected to the first core;
providing the data comparator, operatively connected to the first data queue and the second data queue; and
providing the average generator, running on the first core, executing the steps of:
receiving a first data block set;
receiving a second data block set;
activating the data comparator to generate a comparison of one of a set of time stamps and a set of alert types from the first data block set and the second data block set;
generating an average time stamp from the set of time stamps; and
generating an average alert type from the set of alert types.
